(19) United States
(12) Patent Application Publication
(10) Pub. No.: US 2018/0227979 A1
(43) Pub. Date: Aug. 9, 2018

(54) COMMUNICATION APPARATUS, CONTROL METHOD, AND STORAGE MEDIUM

(71) Applicant: CANON KABUSHIKI KAISHA, Tokyo (JP)

(72) Inventor: Ryosuke SATO, Tokyo (JP)

(21) Appl. No.: 15/506,168

(22) PCT Filed: Sep. 18, 2015
(86) PCT No.: PCT/JP2015/004799

§ 371 Date: Feb. 23, 2017

(30) Foreign Application Priority Data
Oct. 2, 2014 (JP) 2014-204215

(51) Int. Cl. H04W 76/19; H04W 76/15; H04L 29/06

(52) U.S. Cl. CPC H04W 76/19; H04W 84/12; H04L 63/18; H04W 76/15

(57) ABSTRACT

A communication apparatus has a first communication function and a second communication function that has lower power consumption than the first communication function, and keeps information for communication based on the first communication function stored, even after the communication based on the first communication function with a partner apparatus is stopped. The communication apparatus determines whether the stored information is valid through communication based on the second communication function with the partner apparatus, and resumes the communication based on the first communication function with the partner apparatus upon re-obtaining the information for the communication based on the first communication function from the partner apparatus when at least a part of the stored information is not valid, and without re-obtaining the information for the communication based on the first communication function from the partner apparatus when the stored information is valid.

### TECHNICAL FIELD

The present invention relates to a communication apparatus, a control method, and a storage medium, and specifically to a technique to resume wireless communication that has been stopped.

### BACKGROUND ART

In recent years, many communication devices have a wireless LAN (WLAN) function and are capable of communicating with other communication devices that have the WLAN function. Such communication devices typically operate with power supply from a built-in battery. This has led to demand for the communication devices to use less power for the WLAN communication function.

In view of this, Japanese Patent Laid-Open No. 2007-306201 describes a communication apparatus that has a first communication function of performing communication with low power consumption and a second communication function of performing data communication; and performs communication with the first communication function and sets the second communication function in a sleep mode except for a time period in which actual data communication is performed.

Various communication protocols are used in WLAN communication between communication devices. For example, IP addresses are allocated using the Dynamic Host Configuration Protocol (DHCP), and data transfer is performed using the Transmission Control Protocol (TCP). With these communication protocols, parameter information and state information are shared between devices that communicate with each other, thereby enabling subsequent communication. For example, with DHCP, IP addresses and the states of allocation thereof are shared between a DHCP client and a DHCP server. On the other hand, with TCP, the state of connection between a client and a server, port numbers of each connection, and the like are shared.

If shared information and the states of connection related to upper-layer protocols are cleared when WLAN communication is stopped, start processing must be re-executed with respect to all communication protocols when resuming communication; this increases processing overhead. In contrast, Japanese Patent Laid-Open No. 2012-217130 describes a mobile terminal in which the state of an in-use function is stored in association with an external device ID upon detection of release of connection with an external device, and at the time of re-connection, the external device ID of the external device to be re-connected is obtained, and information that has been stored in association with the obtained ID is extracted and used. However, for example, with regard to processing for allocating IP addresses using DHCP, an IP address that was allocated to a DHCP client at the time of disconnection of WLAN connection may not be usable at the time of WLAN re-connection; that is to say, the state at the time of disconnection is not always restorable. If communication is nonetheless resumed using information at the time of disconnection, problems could possibly arise in resumed communication.

The present invention has been made in view of the above problems, and provides a technique to enable a communication apparatus that stops and resumes a communication function to execute appropriate communication resuming processing in accordance with the state at the time of stopping communication and the state at the time of resuming communication.

### SUMMARY OF INVENTION

According to one aspect of the present invention, there is provided a communication apparatus, comprising: storage means for keeping information for wireless LAN communication compliant with IEEE 802.11 standards stored therein, even after the wireless LAN communication with a partner apparatus involved with communication is stopped, the information having been obtained from the partner apparatus; determination means for determining whether the information stored in the storage means is valid through Bluetooth communication with the partner apparatus; and communication means for resuming the wireless LAN communication with the partner apparatus upon re-obtaining the information for the wireless LAN communication from the partner apparatus in a case where at least a part of the information stored in the storage means is not valid, and without re-obtaining the information for the wireless LAN communication from the partner apparatus in a case where the information stored in the storage means is valid.

According to another aspect of the present invention, there is provided a communication apparatus, comprising: storage means for storing information for wireless LAN communication compliant with IEEE 802.11 standards, the information having been provided to a partner apparatus involved with communication; and notification means for, in a case where at least a part of the information stored in the storage means has been changed or inactivated, notifying the partner apparatus of the change or the inactivation of the at least part of the information through Bluetooth communication.

According to still another aspect of the present invention, there is provided a communication apparatus with a first communication function and a second communication function that has lower power consumption than the first communication function, the communication apparatus comprising: storage means for keeping information for communication based on the first communication function stored therein, even after the communication based on the first communication function with a partner apparatus involved with communication is stopped, the information having been obtained from the partner apparatus; determination means for determining whether the information stored in the storage means is valid through communication based on the second communication function with the partner apparatus; and communication means for resuming the communication based on the first communication function with the partner apparatus upon re-obtaining the information for the communication based on the first communication function from the partner apparatus in a case where at least a part of the information stored in the storage means is not valid, and without re-obtaining the information for the communication based on the first communication function from the partner apparatus in a case where the information stored in the storage means is valid.

According to yet another aspect of the present invention, there is provided a communication apparatus with a first communication function and a second communication function that has lower power consumption than the first communication function, the communication apparatus comprising: storage means for storing information for communication based on the first communication function, the information having been provided to a partner apparatus involved with communication; and notification means for, in a case where at least a part of the information stored in the storage means has been changed or inactivated, notifying the partner apparatus of the change or the inactivation of the at least part of the information through communication based on the second communication function.

Further features of the present invention will become apparent from the following description of exemplary embodiments (with reference to the attached drawings).

### BRIEF DESCRIPTION OF DRAWINGS

The accompanying drawings, which are incorporated in and constitute a part of the specification, illustrate embodiments of the invention, and together with the description, serve to explain the principles of the invention.

FIG. 1 shows an exemplary configuration of a wireless communication system.

FIG. 2 is a block diagram showing an exemplary hardware configuration of a communication apparatus.

FIG. 3 is a block diagram showing an exemplary functional configuration of a smartphone.

FIG. 4 is a block diagram showing an exemplary functional configuration of a digital camera.

FIG. 5 is a flowchart showing an exemplary flow of processing of a smartphone according to a first embodiment.

FIG. 6 is a flowchart showing an exemplary flow of WLAN connection processing of the smartphone.

FIG. 7 is a flowchart showing an exemplary flow of WLAN re-connection processing of the smartphone according to the first embodiment.

FIG. 8 is a flowchart showing an exemplary flow of processing of a digital camera according to the first embodiment.

FIG. 9 shows a format of a changed connection state notification packet according to the first embodiment.

FIG. 10 is a sequence diagram showing an exemplary flow of processing executed in a wireless communication system according to the first embodiment.

FIG. 11A shows an exemplary screen displayed on the smartphone.

FIG. 11B shows an exemplary screen displayed on the smartphone.

FIG. 11C shows an exemplary screen displayed on the smartphone.

FIG. 11D shows an exemplary screen displayed on the smartphone.

FIG. 11E shows an exemplary screen displayed on the smartphone.

FIG. 12 is a flowchart showing an exemplary flow of processing of a smartphone according to a second embodiment.

FIG. 13A is a flowchart showing an exemplary flow of WLAN re-connection processing of the smartphone according to the second embodiment.

FIG. 13B is a flowchart showing an exemplary flow of the WLAN re-connection processing of the smartphone according to the second embodiment.

FIG. 14 is a flowchart showing an exemplary flow of the WLAN re-connection processing of the smartphone according to the second embodiment.

FIG. 15 is a flowchart showing an exemplary flow of processing of a digital camera according to the second embodiment.

FIG. 16 is a flowchart showing an exemplary flow of the processing of the digital camera according to the second embodiment.

FIG. 17 shows a format of a changed connection state notification packet according to the second embodiment.

FIG. 18 shows exemplary attribute values set in a changed connection state notification according to the second embodiment.

FIG. 19 is a sequence diagram showing an exemplary flow of processing executed in a wireless communication system according to the second embodiment.

### DESCRIPTION OF EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

Below, each communication apparatus has a first communication function for data communication and a second communication function with low power consumption, and controls stopping and resuming of the first communication function using the second communication function. It will be assumed that, in the present embodiments, a wireless LAN (WLAN) is used as the first communication function, and Bluetooth (registered trademark) Low Energy (hereinafter referred to as “BLE”) is used as the second communication function. It should be noted that BLE is a communication technique standardized in Bluetooth (registered trademark) 4.0, and enables communication with low power consumption compared to version 3.0 and older versions of Bluetooth, and a WLAN. A wireless LAN may be, for example, a wireless LAN compliant with any of the standards of the IEEE 802.11 standard series, and may be a wireless LAN compliant with other standards.

(Wireless Communication System)

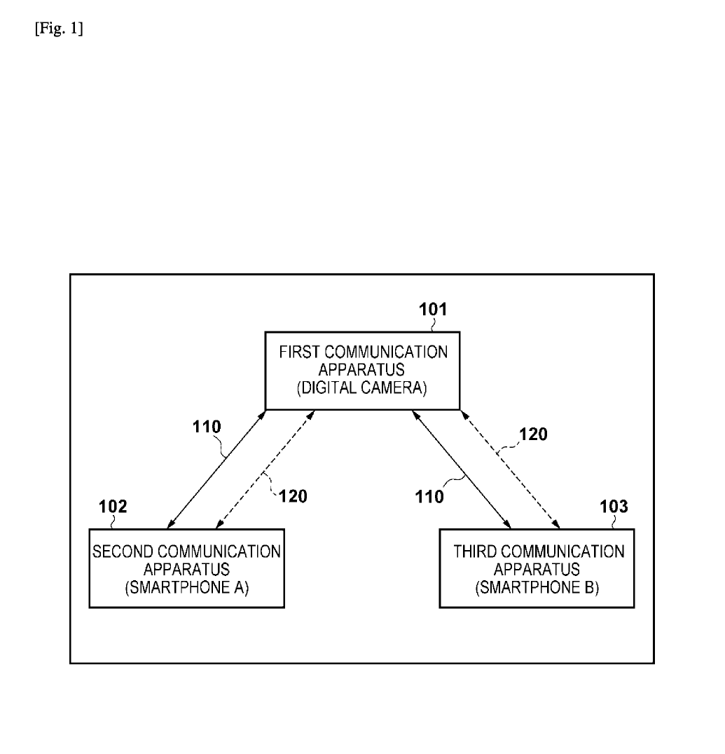

FIG. 1 shows an exemplary configuration of a wireless communication system according to later-described embodiments. The present wireless communication system includes, for example, a first communication apparatus 101, a second communication apparatus 102, and a third communication apparatus 103. Below, it will be assumed that the first communication apparatus 101 is a digital camera, and the second communication apparatus 102 and the third communication apparatus 103 are smartphones. Communication between the digital camera 101 and the smartphone 102 or 103 is performed via connection 110 based on the first communication function (wireless LAN), and via connection 120 based on the second communication function (BLE). It should be noted that the first communication function enables communication at high speed compared to the second communication function, whereas the second communication function enables communication with low power consumption compared to the first communication function.

(Configuration of Communication Apparatuses)

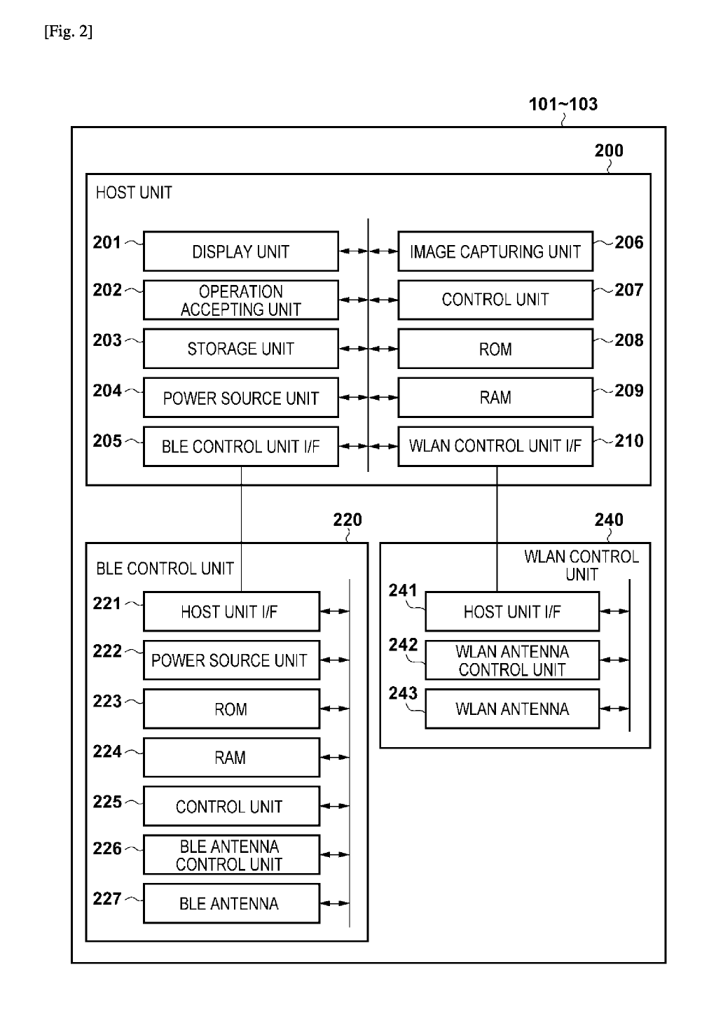

FIG. 2 shows an exemplary hardware configuration of the digital camera 101 and the smartphone 102 or 103. The digital camera 101 and the smartphone 102 or 103 include, for example, a host unit 200, a BLE control unit 220, and a WLAN control unit 240.

The host unit 200 includes, for example, a display unit 201, an operation accepting unit 202, a storage unit 203, a power source unit 204, a BLE control unit I/F 205, an image capturing unit 206, a control unit 207, a ROM 208, a RAM 209, and a WLAN control unit I/F 210. The BLE control unit 220 includes a host unit I/F 221, a power source unit 222, a ROM 223, a RAM 224, a control unit 225, a BLE antenna control unit 226, and a BLE antenna 227. The WLAN control unit 240 includes a host unit I/F 241, a WLAN antenna control unit 242, and a WLAN antenna 243.

The display unit 201 and the operation accepting unit 202, for example, accept user operations for display and execution of applications. The storage unit 203 stores and manages various types of data, such as wireless communication network information, data transmission/reception information, and image data. The power source unit 204 is, for example, a battery, and supplies power to the host unit 200 and the WLAN control unit 240. The BLE control unit I/F 205 is an interface for connecting the BLE control unit 220 and the host unit 200. The image capturing unit 206, for example, shoots photographs and moving images when the operation accepting unit 202 accepts a user operation. The control unit 207, for example, includes one or more CPUs and controls the operations of constituent elements of the digital camera 101 and the smartphone 102 or 103. The ROM 208 is a storage apparatus storing control instructions, that is to say, programs. The RAM 209 is a storage apparatus that is, for example, used as a working memory in executing programs, and used to temporarily store data. The WLAN control unit I/F 210 is an interface for connecting the WLAN control unit 240 and the host unit 200.

The host unit I/F 221 is an interface for connecting the host unit 200 and the BLE control unit 220. The power source unit 222 is, for example, a battery, and supplies power to the BLE control unit 220. The ROM 223 is a storage apparatus storing control instructions, that is to say, programs; herein, it particularly stores programs related to BLE communication. The RAM 224 is a storage apparatus that is, for example, used as a working memory in executing programs, and used to temporarily store data. The control unit 225, for example, includes one or more CPUs and controls the operations of constituent elements of the BLE control unit 220. The BLE antenna control unit 226 controls the BLE antenna 227, and BLE communication is performed through radiation and reception of electromagnetic waves via the BLE antenna 227.

The host unit I/F 241 is an interface for connecting the host unit 200 and the WLAN control unit 240. The WLAN antenna control unit 242 controls the WLAN antenna 243, and WLAN communication is performed through radiation and reception of electromagnetic waves via the WLAN antenna 243.

Although FIG. 2 shows exemplary hardware components that can be mutually provided in the digital camera 101 and the smartphone 102 or 103, each of these apparatuses may further include other hardware components (not shown) that are specific to itself.

(Functional Configuration of Smartphones)

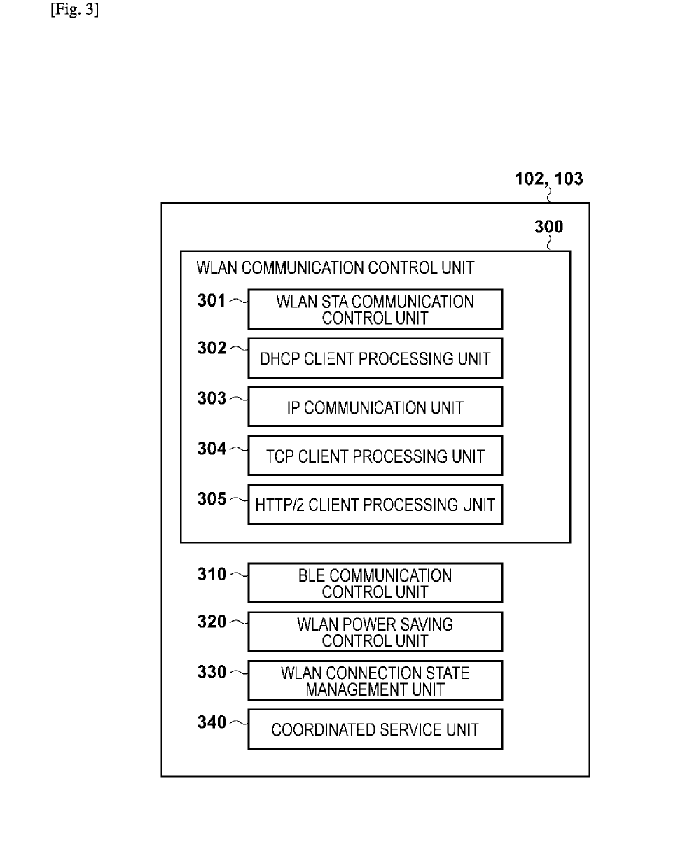

A description is now given of a functional configuration of the smartphones 102 and 103 with reference to FIG. 3. Although the functions of the functional blocks described below are realized as software programs in the present embodiments, a part or all of these functional blocks may be realized by hardware. The smartphones 102 and 103 include, for example, the following functions: a WLAN communication control unit 300, a BLE communication control unit 310, a WLAN power saving control unit 320, a WLAN connection state management unit 330, and a coordinated service unit 340.

The WLAN communication control unit 300 is a processing unit that controls wireless LAN communication performed via the WLAN antenna control unit 242. A processing sequence of the WLAN communication control unit 300 is executed by the control unit 207 executing a program stored in the ROM 208. The WLAN communication control unit 300 includes, for example, a WLAN STA communication control unit 301, a DHCP client processing unit 302, an IP communication unit 303, a TCP client processing unit 304, and an HTTP/2 client processing unit 305.

The WLAN STA communication control unit 301 is a processing unit that controls communication as a wireless LAN station (STA). The DHCP client processing unit 302 is a processing unit that operates as a client based on the Dynamic Host Configuration Protocol (DHCP). The IP communication unit 303 is a processing unit that controls communication based on the Internet Protocol (IP). The TCP client processing unit 304 is a processing unit that operates as a client based on the Transmission Control Protocol (TCP). The HTTP/2 client processing unit 305 is a processing unit that operates as a client based on the Hypertext Transfer Protocol version 2 (HTTP/2).

The BLE communication control unit 310 is a processing unit that controls BLE communication performed via the BLE antenna control unit 226. A processing sequence of the BLE communication control unit 310 is executed by the control unit 225 executing a program stored in the ROM 223.

The WLAN power saving control unit 320 is a processing unit that is intended to save power by turning on/off the functions of the WLAN control unit 240. The WLAN power saving control unit 320 is stored in the ROM 208 as a program, and the functions thereof are implemented by the control unit 207 executing the program.

The WLAN connection state management unit 330 manages information that includes at least one of parameters, a communication state, and the like, and that is shared with a communication partner apparatus (e.g., the digital camera 101) in various types of communication protocol processing executed by the WLAN communication control unit 300. A processing sequence of the WLAN connection state management unit 330 is executed by the control unit 207 executing a program stored in the ROM 208. Below, the information managed by the WLAN connection state management unit 330, i.e., the information including parameters, a communication state, and the like, is referred to as shared parameters.

The coordinated service unit 340 is a processing unit that executes services in coordination with the digital camera 101 via wireless LAN communication by the WLAN communication control unit 300. In the present embodiments, for example, the coordinated service unit 340 executes processing for obtaining thumbnail images from the digital camera 101, displaying a list of obtained thumbnail images on the display unit 201, and obtaining actual image data of thumbnails selected by an operation on the operation accepting unit 202 from the digital camera 101. A processing sequence of the coordinated service unit 340 is executed by the control unit 207 executing a program stored in the ROM 208.

(Functional Configuration of Digital Camera)

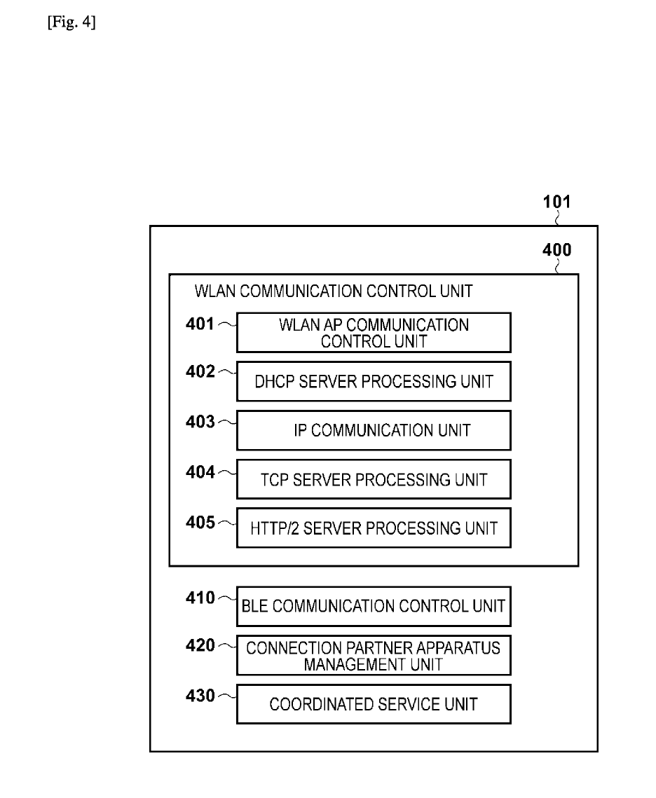

FIG. 4 shows an exemplary functional configuration of the digital camera 101. Although the functions of the functional blocks described below are realized as software programs in the present embodiments, a part or all of these functional blocks may be realized by hardware. The digital camera 101 includes, for example, the following functions: a WLAN communication control unit 400, a BLE communication control unit 410, a connection partner apparatus management unit 420, and a coordinated service unit 430.

The WLAN communication control unit 400 is a processing unit that controls wireless LAN communication performed via the WLAN antenna control unit 242. A processing sequence of the WLAN communication control unit 400 is executed by the control unit 207 executing a program stored in the ROM 208. The WLAN communication control unit 400 includes, for example, a WLAN AP communication control unit 401, a DHCP server processing unit 402, an IP communication unit 403, a TCP server processing unit 404, and an HTTP/2 server processing unit 405.

The WLAN AP communication control unit 401 is a processing unit that controls communication as a wireless LAN access point (AP). The DHCP server processing unit 402 is a processing unit that operates as a server based on DHCP. The IP communication unit 403 is a processing unit that controls communication based on IP. The TCP server processing unit 404 is a processing unit that operates as a server based on TCP. The HTTP/2 server processing unit 405 is a processing unit that operates as a server based on HTTP/2.

The BLE communication control unit 410 is a processing unit that controls BLE communication performed via the BLE antenna control unit 226. A processing sequence of the BLE communication control unit 410 is executed by the control unit 225 executing a program stored in the ROM 223.

The connection partner apparatus management unit 420 is a control unit that manages the state of connection with a partner apparatus (e.g., the smartphone 102 or 103) with which communication is performed via the WLAN communication control unit 400. The connection partner apparatus management unit 420 manages the state of connection for wireless LAN communication and BLE communication with a partner apparatus. With regard to a partner apparatus with which wireless LAN connection is not established, the connection partner apparatus management unit 420 stores and manages shared parameters in the storage unit 203 when wireless LAN communication with that partner apparatus is disconnected (stopped). A processing sequence of the connection partner apparatus management unit 420 is executed by the control unit 225 executing a program stored in the ROM 223.

The coordinated service unit 430 is a processing unit that executes services in coordination with the smartphone 102 or 103 via wireless LAN communication by the WLAN communication control unit 400. In the present embodiments, for example, the coordinated service unit 430 transmits image identifiers, thumbnail images, and actual image data stored in the storage unit 203 in response to a request from the smartphone 102 or 103. A processing sequence of the coordinated service unit 430 is executed by the control unit 207 executing a program stored in the ROM 208.

Although it has been described above that the digital camera 101 operates as a wireless LAN AP, a DHCP server, a TCP server, and an HTTP/2 server in the present embodiments, the smartphone 102 may fulfill such roles. In this case, the digital camera 101 can operate as a wireless LAN STA, a DHCP client, a TCP client, and an HTTP/2 client. It should be noted that a wireless LAN STA does not necessarily have to serve as a DHCP, TCP, and HTTP/2 client, and may function as a server based on at least one of these protocols. That is to say, roles based on various protocols need not necessary be in coordination with one another, and may be independent of one another.

(Processing Flow)

A description is now given of some embodiments related to flows of processing executed by at least one of the above-described wireless communication system, digital camera 101, and smartphone 102 or 103.

### First Embodiment

(Processing of Smartphone)

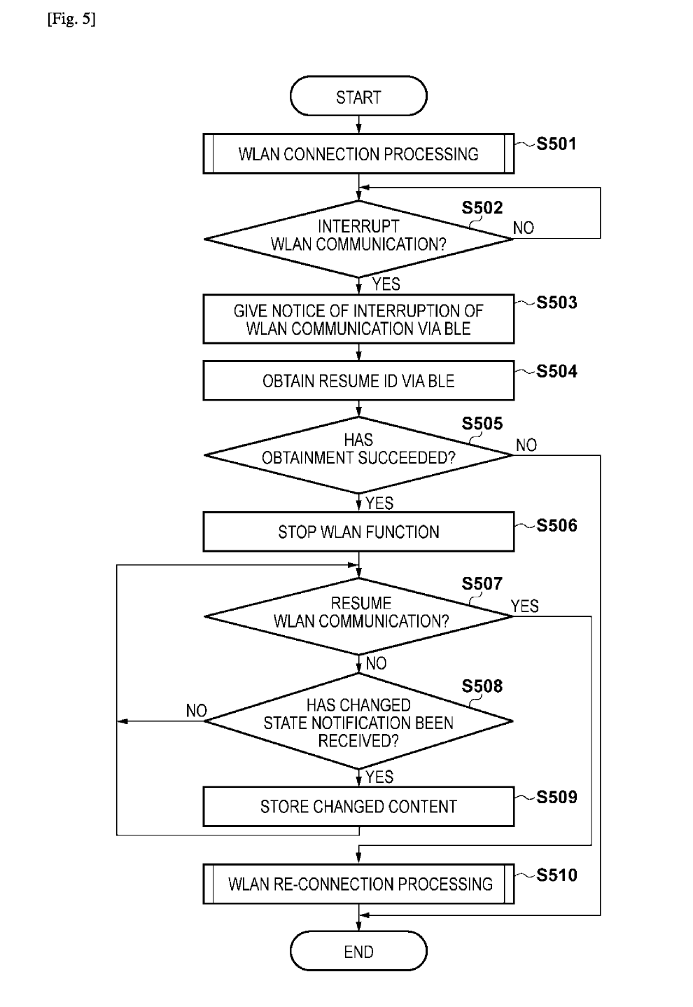

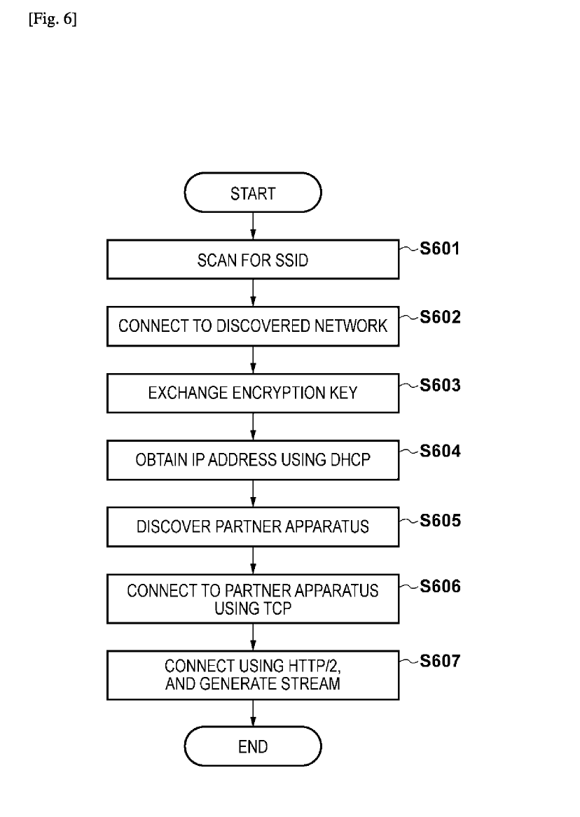

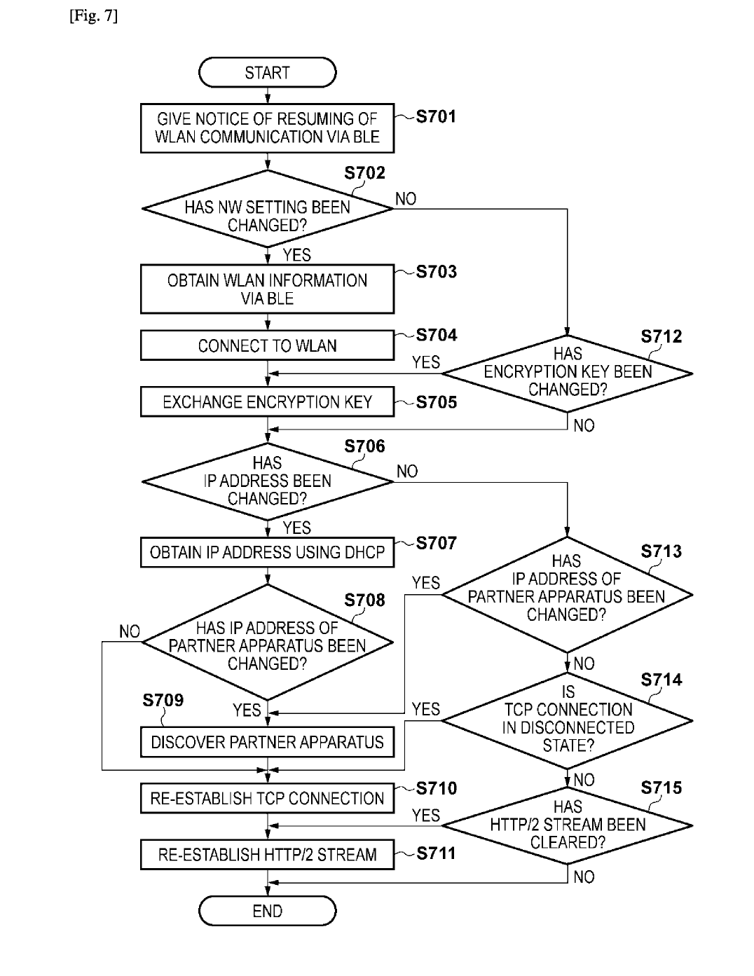

The flow of processing executed by the smartphone 102 or 103 according to the present embodiment will now be described with reference to flowcharts of FIGS. 5 to 7. FIG. 5 shows a processing flow for a case in which the smartphone 102 or 103 establishes connection via a wireless LAN, stops communication via the wireless LAN, and then resumes the communication. FIG. 6 shows the flow of wireless LAN connection processing, and FIG. 7 shows the flow of wireless LAN re-connection processing. It should be noted that the flowcharts of FIGS. 5 to 7 are realized by, for example, the control unit 207 reading out and executing programs stored in the ROM 208 in the smartphone 102 or 103. In the following description, out of the smartphones 102 and 103, the smartphone 102 executes processing.

Referring to FIG. 5, the smartphone 102 first executes wireless LAN connection processing (step S501). For example, the smartphone 102 executes the wireless LAN connection processing in association with a coordinated service executed by the coordinated service unit 340. Below, it will be assumed that the coordinated service unit 340 executes processing for obtaining thumbnail images from the digital camera 101, displaying a list of obtained thumbnail images on the display unit 201, and obtaining actual image data of thumbnails selected by an operation on the operation accepting unit 202 from the digital camera 101. It should be noted that this processing is executed, for example, when a user of the smartphone 102 has selected a function of obtaining image data from the digital camera 101 by operating the operation accepting unit 202.

A detailed processing flow of the connection processing executed in step S501 will now be described with reference to FIG. 6. The smartphone 102 performs this connection processing in accordance with an operation procedure shown in FIG. 6, from WLAN connection to connection using upper-layer protocols. First, the WLAN STA communication control unit 301 of the smartphone 102 searches the storage unit 203 for a service set identifier (SSID) of a wireless LAN generated by the digital camera 101 (step S601). It should be noted that an SSID is a network identifier that identifies one network.

Upon discovery of the SSID of the network generated by the digital camera 101, the WLAN STA communication control unit 301 connects to the network having the SSID via a communication channel in which the SSID was discovered (step S602). The WLAN STA communication control unit 301 also executes sharing processing for sharing, with the digital camera 101, an encryption key used in WLAN communication (step S603). It should be noted that the smartphone 102 and the digital camera 101 share an encryption key for unicast communication through, for example, a four-way handshake defined in the IEEE 802.11 standards. Similarly, the smartphone 102 and the digital camera 101 share an encryption key for multicast communication through, for example, a two-way handshake defined in the IEEE 802.11 standards.

Next, using DHCP, the DHCP client processing unit 302 obtains an IP address used by the smartphone 102 from the DHCP server processing unit 402 of the digital camera 101 (step S604). Subsequently, via the IP communication unit 303, the coordinated service unit 340 searches for a partner apparatus (in the present case, the digital camera 101) that supports a coordinated function to be implemented, and obtains an IP address of the partner apparatus (step S605). It should be noted that this search processing is executed using, for example, the Simple Service Discovery Protocol (SSDP). Once the IP address of the digital camera 101 has been obtained, the TCP client processing unit 304 executes processing for TCP connection with respect to the obtained IP address (step S606). Upon completion of the TCP connection, the HTTP/2 client processing unit 305 establishes a session and a stream based on the HTTP/2 protocol with the digital camera 101 over the TCP connection (step S607).

Returning to FIG. 5, the smartphone 102 determines whether to interrupt wireless LAN connection during the execution of a service after completion of the wireless LAN connection (step S502). Here, for example, the coordinated service unit 340 makes the determination of whether to stop a wireless LAN communication function by interrupting the wireless LAN connection.

The coordinated service unit 340 makes the determination of whether to stop the wireless LAN communication function, for example, as follows. Once the wireless LAN connection has been established, the coordinated service unit 340 obtains a list of image IDs held by the digital camera 101 from the digital camera 101 via the HTTP/2 client processing unit 305. It should be noted that image IDs are, for example, four-byte numeric values allocated to image files in the digital camera 101. Thereafter, once the coordinated service unit 340 has obtained thumbnail images corresponding to the obtained image IDs from the digital camera 101 via the HTTP/2 client processing unit, it decides to interrupt wireless LAN communication. That is to say, communication is not required while the coordinated service unit 340 executes processing for displaying a list of obtained thumbnail images on the display unit 201 and causing the user to select target thumbnail images whose actual image data should be obtained. For this reason, once the coordinated service unit 340 has obtained the thumbnail images, it decides to interrupt the wireless LAN communication. It should be noted that this determination may be made by another functional unit. With regard to applications other than image sharing applications, the coordinated service unit 340 can also determine that communication should be interrupted in a time period in which communication is not required.

If it is determined that the wireless LAN communication should be interrupted (YES of step S502), for example, the coordinated service unit 340 notifies the digital camera 101 of interruption of the wireless LAN communication via the BLE communication control unit 310 (step S503). Then, the smartphone 102 obtains a resume ID from the digital camera 101 (step S504). Resume IDs are, for example, one-byte numeric values allocated by the digital camera 101, and the digital camera 101 manages shared parameters for each resume ID. If the resume ID has been successfully obtained (YES of step S505), the WLAN power saving control unit 320 stops power supply to the WLAN control unit 240, thereby stopping the wireless LAN communication function (step S506). On the other hand, if the obtainment of the resume ID has failed (NO of step S505), processing is ended without stopping the wireless LAN communication function. In this case, for example, the coordinated service unit 340 displays the thumbnails and accepts image selections by the user while leaving the wireless LAN communication function in an on state.

Via BLE communication, the WLAN connection state management unit 330 waits for reception of a changed state notification packet from the digital camera 101 (step S508) until the decision to resume the wireless LAN communication is made (NO of step S507). It should be noted that, for example, the coordinated service unit 340 determines whether to resume the wireless LAN communication. That is to say, for example, if the coordinated service unit 340 detects the execution of a user operation on the operation accepting unit 202 for obtaining actual image data, it decides to resume the wireless LAN communication to obtain the actual image data. It should be noted that, with regard to other applications, the coordinated service unit 340 can also decide to resume the wireless LAN communication upon detection of some kind of event that requires high-speed communication after the wireless LAN communication function has been stopped. Upon receiving the changed state notification packet from the digital camera 101 via BLE (YES of step S508), the WLAN connection state management unit 330 stores shared parameters or protocol types of such parameters that have been changed, into the storage unit 203 (step S509).

For example, a changed state notification packet is structured as shown in FIG. 9. It should be noted that the data format of the changed state notification packet shown in FIG. 9 is merely an example, and the changed state notification packet does not necessarily have to be transmitted/received in this format. A changed connection state notification packet 900 is a message that is periodically broadcast by the digital camera 101 via BLE communication. The changed connection state notification packet 900 contains, for example, a preamble 901, an access address 902, a header 903, a length 904, an advertiser address 905, service data 906, and CRC 907. The preamble 901 is a one-byte (eight-bit) value used for frequency synchronization with a receiving apparatus in BLE communication. The access address 902 is a four-byte value; for example, 0x8E89BED6 is set as a value thereof in the changed state notification packet. The header 903 is a one-byte value as which a value indicating a packet type of fields from the length 904 is designated. The length 904 is a one-byte value indicating the data length of a combination of the advertiser address 905 and the service data 906. The advertiser address 905 is the address of a packet transmitter, that is to say, the address of the digital camera 101 in the present embodiment. The CRC 907 is a three-byte value for detecting data error in the changed connection state notification packet 900.

The service data 906 contains data indicating whether a communication state has been changed (changed connection state). The changed connection state indicates whether shared parameters for communication protocols that were used in wireless LAN communication at the time of interruption are valid or invalid. The service data 906 contains, for example, a type 908, a length 909, and states 910 that correspond in number to issued resume IDs. The type 908 is a one-byte value indicating the type of data designated as the service data 906, and a value indicating the changed connection state data is designated thereas. The length 909 is the data size of a combination of the states 910 that are designated thereafter. Each state 910 indicates, for a certain resume ID, whether shared parameters for communication protocols that were used in wireless LAN communication at the time of interruption are valid or invalid. Each state 910 contains, for example, a resume ID 911 and changed parameter bits 912. The resume ID 911 is an identifier having a one-byte value, allocated by the transmitter of the changed state notification packet (in the present case, the digital camera 101) to a corresponding communication apparatus that has interrupted wireless LAN communication. The changed parameter bits 912 (hereinafter referred to as “CPB”) are bit flags indicating whether shared parameters that were used at the time of interruption of wireless LAN communication with the communication apparatus to which the resume ID 911 is allocated, have been changed thereafter. The bits correspond to a connection state and network setting of the wireless LAN, a unicast key of the wireless LAN, a broadcast key of the wireless LAN, an IP address of a client, an IP address of a server, TCP connection, and an HTTP/2 session. A bit having a value of 1 indicates that the corresponding shared parameter has been changed after the interruption of wireless LAN communication.

Based on the resume ID obtained in step S504, the WLAN connection state management unit 330 refers to the CPB 912 in the state 910 whose resume ID 911 is the same as the obtained resume ID within the changed state notification packet. In this way, the WLAN connection state management unit 330 acknowledges that shared parameters for protocols have been changed if the corresponding bits in the CPB have a value of 1.

For example, if the coordinated service unit 340 decides to resume wireless LAN communication (YES of step S507), the WLAN connection state management unit 330 executes processing for re-connection with the digital camera 101 via the wireless LAN (step S510). The details of this re-connection processing will now be described with reference to FIG. 7.

In the re-connection processing, first, the WLAN connection state management unit 330 notifies the partner apparatus (digital camera 101) of resuming of wireless LAN communication via the BLE communication control unit 310 (step S701). The WLAN connection state management unit 330 then refers to the information stored in step S509, and searches for shared parameters that were changed after the wireless LAN communication function was stopped, as well as the protocol types of such shared parameters.

Thereafter, the WLAN connection state management unit 330 determines whether a connection state and network setting of the wireless LAN have been changed (step S702). If the connection state and network setting of the wireless LAN have been changed (YES of step S702), the WLAN connection state management unit 330 obtains changed setting information of the wireless LAN from the digital camera 101 via the BLE communication control unit 310 (step S703). It should be noted that this setting information includes, for example, at least one of a network identifier (SSID), a channel number (frequency information) to be used, an encryption type, an authentication type, and encryption key data for unicast or multicast. Thereafter, using the setting information obtained in step S703, the WLAN STA communication control unit 301 connects to a network that is generated by the digital camera 101 using the wireless LAN communication function (step S704), and executes processing for sharing an encryption key with the digital camera 101 (step S705). That is to say, when the network setting has been changed, processing for sharing not only the changed setting information, but also an encryption key that is accordingly changed, is executed. Even in a case where the connection state and network setting of the wireless LAN have not been changed (NO of step S702), the WLAN STA communication control unit 301 executes the processing for sharing the encryption key with the digital camera 101 (S705) if the encryption key has been changed (YES of step S712).

Next, the WLAN connection state management unit 330 determines whether the IP address allocated to the smartphone 102 has been changed or inactivated (step S706). If the IP address allocated to the smartphone 102 has been changed or inactivated (YES of step S706), the DHCP client processing unit 302 obtains an IP address to be used by the smartphone 102 using DHCP (step S707). Thereafter, the WLAN connection state management unit 330 determines whether the IP address of the partner apparatus (digital camera 101) has been changed (step S708). It should be noted that the WLAN connection state management unit 330 determines whether the IP address of the partner apparatus has been changed (step S713) also in a case where the IP address allocated to the smartphone 102 has not been changed or inactivated (NO of step S706). If the IP address of the partner apparatus has been changed (YES of step S708 or S713), the coordinated service unit 340 obtains an IP address of the digital camera 101 using SSDP (step S709).

If either one of the IP addresses allocated to the smartphone 102 and the digital camera 101 has been changed or inactivated (YES of step S706 or S713), the WLAN connection state management unit 330 can determine that TCP connection has been disconnected accordingly. Similarly, the WLAN connection state management unit 330 can also determine that the session and the stream based on HTTP/2 have been discarded in accordance with the change or inactivation of the IP address. Therefore, in a case where the IP address of either one of the communication apparatuses has been changed or inactivated, the WLAN connection state management unit 330 executes processing for re-establishing TCP connection via the TCP client processing unit 304 (step S710). Similarly, the WLAN connection state management unit 330 executes processing for re-establishing a session and a stream based on HTTP/2 via the HTTP/2 client processing unit 305 (step S711).

If neither of the IP addresses allocated to the smartphone 102 and the digital camera 101 has been changed (NO of steps S706 and S713), the WLAN connection state management unit 330 subsequently determines whether TCP connection has been disconnected (step S714). If the TCP connection has been disconnected (YES of step S714), the WLAN connection state management unit 330 executes processing for re-establishing TCP connection (step S710), and accordingly processing for re-establishing a session and a stream based on HTTP/2 (step S711). If the TCP connection has not been disconnected (NO of step S714), the WLAN connection state management unit 330 subsequently determines whether the session or the stream based on HTTP/2 has been cleared (step S715). If the session or the stream based on HTTP/2 has been cleared (YES of step S715), the WLAN connection state management unit 330 executes processing for re-establishing a session and a stream based on HTTP/2 (step S711). It should be noted that, if the processing of FIG. 7 has failed, the WLAN connection state management unit 330 determines that the wireless LAN re-connection processing has failed, and stops the wireless LAN communication function again (not shown).

Upon completion of the wireless LAN re-connection processing, the coordinated service unit 340, for example, obtains data of images that have been designated by a user's operation on the operation accepting unit 202 from the digital camera 101 via the HTTP/2 client processing unit. Upon completion of obtainment of image data, the WLAN STA communication control unit 301 disconnects wireless LAN communication with the digital camera 101. In this case, as re-connection is not intended afterwards, the smartphone 102 does not notify the digital camera 101 of the interruption of wireless LAN communication. Therefore, no resume ID is issued. Once the wireless LAN communication has been disconnected, the WLAN power saving control unit 320 stops power supply to the WLAN control unit 240, thereby stopping the wireless LAN communication function.

The disconnection of wireless LAN communication is carried out also in a case where it is determined in step S505 that the obtainment of the resume ID has failed. That is to say, during a service, in a time period that does not require wireless LAN communication, the wireless LAN communication function is not turned off for the purpose of re-connection processing, unless a resume ID is issued. On the other hand, after the service has ended, the wireless LAN communication function can be turned off, even without a resume ID, because wireless LAN re-connection is not scheduled.

(Processing of Digital Camera)

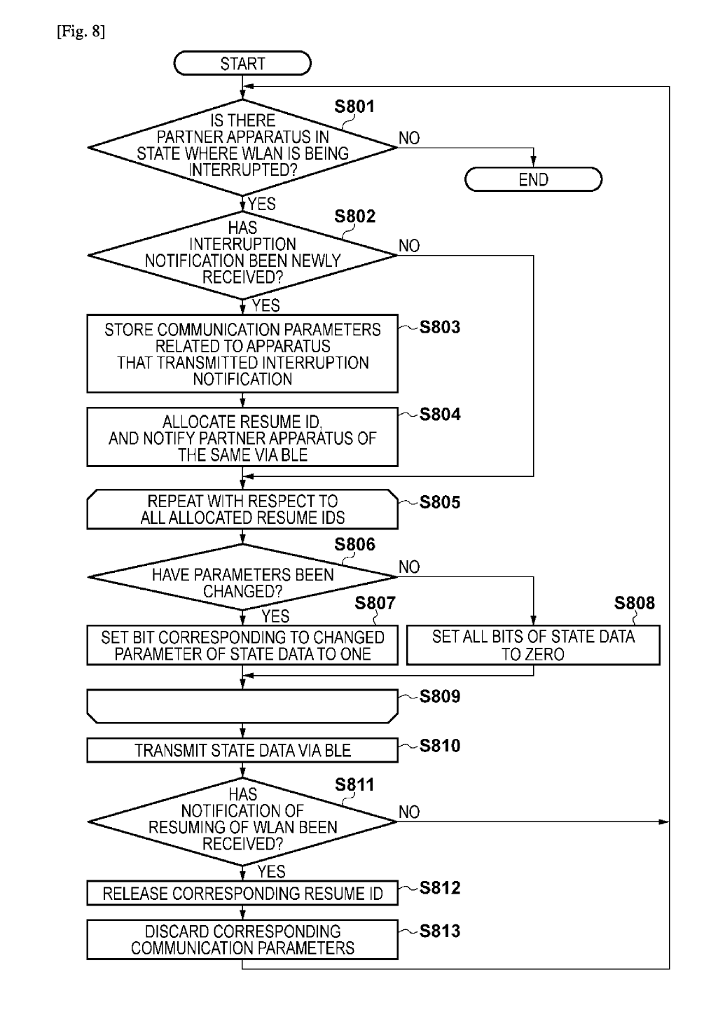

A description is now given of the flow of processing executed by the digital camera 101 according to the present embodiment with reference to a flowchart of FIG. 8. FIG. 8 is a flowchart showing the flow of processing that is constantly executed by the digital camera 101 during implementation of an access point function by the WLAN AP communication control unit 401. It should be noted that the access point function is started when a user selects a menu for starting coordinated processing with a smartphone by operating the operation accepting unit 202 of the digital camera 101.

Referring to FIG. 8, first, the connection partner apparatus management unit 420 confirms whether there is a partner apparatus (in the present case, the smartphone 102 or 103) that is in a state where wireless LAN communication is being interrupted (step S801). It should be noted that the connection partner apparatus management unit 420 determines, via the BLE communication control unit 410, that the partner apparatus that transmitted the notification of interruption of wireless LAN communication in step S503 is the partner apparatus that is in the state where wireless LAN communication is being interrupted. If the connection partner apparatus management unit 420 determines that there is no partner apparatus that is in the state where wireless LAN communication is being interrupted (NO of step S801), the digital camera 101 directly ends the present processing.

It should be noted that the digital camera 101 may periodically execute the present processing while functioning as an AP. The digital camera 101 may also execute the present processing when the BLE communication control unit 410 receives a notification of interruption of wireless LAN communication. That is to say, the digital camera 101 may execute the processes of step S802 onward when the BLE communication control unit 410 receives a notification of interruption of wireless LAN communication without the presence of a partner apparatus in which wireless LAN communication is being interrupted. In this case, the present processing may not be executed when wireless LAN communication has been resumed after all partner apparatuses withdrew from the state where wireless LAN communication is being interrupted.

On the other hand, if the connection partner apparatus management unit 420 determines that there is a partner apparatus that is in the state where wireless LAN communication is being interrupted (YES of step S801), the digital camera 101 repeatedly executes the processes of steps S802 to S813.

The connection partner apparatus management unit 420 determines whether there is a partner apparatus that has been newly placed in the state where wireless LAN communication is being interrupted by transmitting a notification of interruption of wireless LAN communication (step S802). If there is a partner apparatus that has been newly placed in the state where wireless LAN communication is being interrupted (YES of step S802), the connection partner apparatus management unit 420 stores, into the storage unit 203, communication parameters for wireless LAN communication that are shared with this partner apparatus (step S803). It should be noted that the communication parameters include, for example, at least one of a network identifier, a channel number to be used (frequency information to be used), a group encryption key, and an encryption key for unicast communication or multicast communication with the partner apparatus. These communication parameters also include, for example, information indicating a communication state, such as information of the IP addresses of its own and the partner apparatus, a connected TCP session, or a session and a stream based on HTTP/2 . Once the communication parameters have been stored into the storage unit 203, the connection partner apparatus management unit 420 issues and allocates a resume ID corresponding to the communication parameters, and notifies the partner apparatus of the resume ID via the BLE communication control unit 410 (step S804).

Next, the connection partner apparatus management unit 420 checks the communication parameters corresponding to each of the allocated resume IDs (steps S805 to S808), and generates data of the states 910 in the changed connection state notification packet 900 shown in FIG. 9. The connection partner apparatus management unit 420 executes the processes of steps S806 to S808 with respect to each of the allocated resume IDs. For each resume ID, the connection partner apparatus management unit 420 determines whether any of the communication parameters has been changed by comparing the communication parameters that were stored in association with the resume ID with the communication parameters that are currently used (step S806). Through the comparison, the connection partner apparatus management unit 420 determines, for example, whether a channel value used in a wireless LAN that is currently managed by the WLAN AP communication control unit is the same as a value stored in step S803. The connection partner apparatus management unit 420 also determines, for example, whether TCP connection that was established at the time of step S803 is currently still managed in the TCP server processing unit 404 as TCP connection that is already established.

If the connection partner apparatus management unit 420 determines that any of the communication parameters has been changed (YES of step S806), the connection partner apparatus management unit 420 sets a bit corresponding to the changed communication parameter to 1 in the CPB 912 of the state 910 (step S807). For example, if there has been a change in a channel being used in the wireless LAN, the connection partner apparatus management unit 420 sets a WLAN NW setting bit to 1 in the CPB 912. If the connection partner apparatus management unit 420 determines that no communication parameter has been changed (NO of step S806), the connection partner apparatus management unit 420 sets all of the bits to zero in the CPB 912 of the state 910 (step S808). Once the processes of steps S806 to S808 have been completed with respect to all of the allocated resume IDs, the connection partner apparatus management unit 420 broadcasts a changed connection state notification packet 900 containing all of the generated states 910 via the BLE communication control unit 410 (step S810). It should be noted that the changed connection state notification packet 900, for example, is transmitted periodically.

The connection partner apparatus management unit 420 determines whether there is a partner apparatus that has returned from the state where wireless LAN communication is being interrupted (step S811). Here, the connection partner apparatus management unit 420 determines that the partner apparatus that transmitted the notification of resuming of wireless LAN communication, which was received via the BLE communication control unit 410, has returned from the state where wireless LAN communication is being interrupted. It should be noted that this resume notification is a signal transmitted by the partner apparatus in step S701. If there is a partner apparatus that has returned from the state where wireless LAN communication is being interrupted (YES of step S811), the connection partner apparatus management unit 420 removes the resume ID allocated to this partner apparatus (step S812). Then, the connection partner apparatus management unit 420 discards information of communication parameters that is stored in the storage unit 203 in correspondence with the resume ID allocated to this partner apparatus (step S813).

(Flow of Processing in Wireless Communication System)

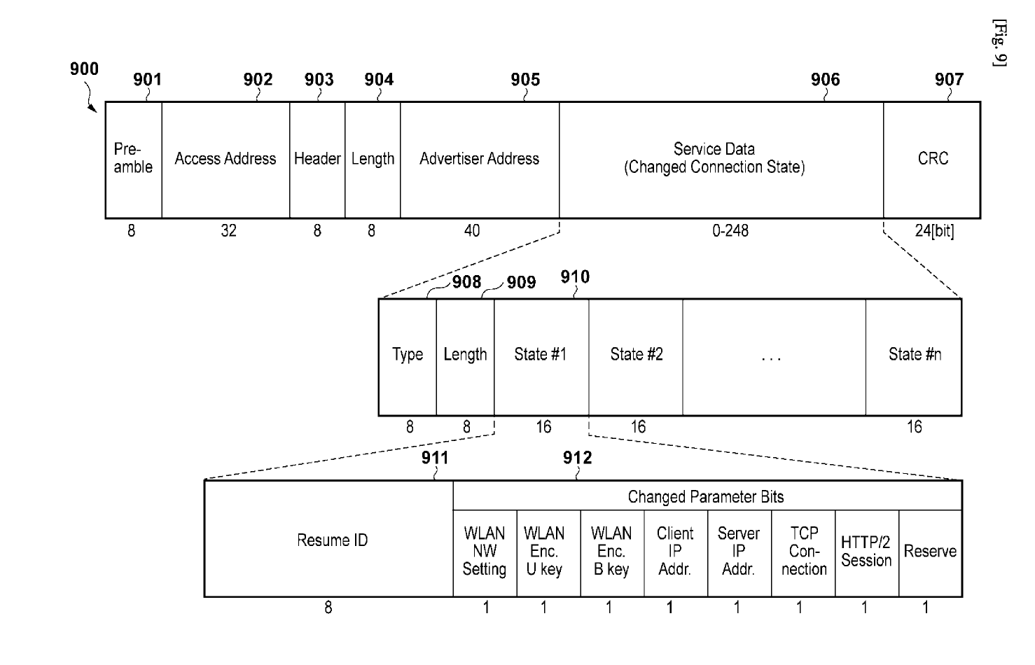

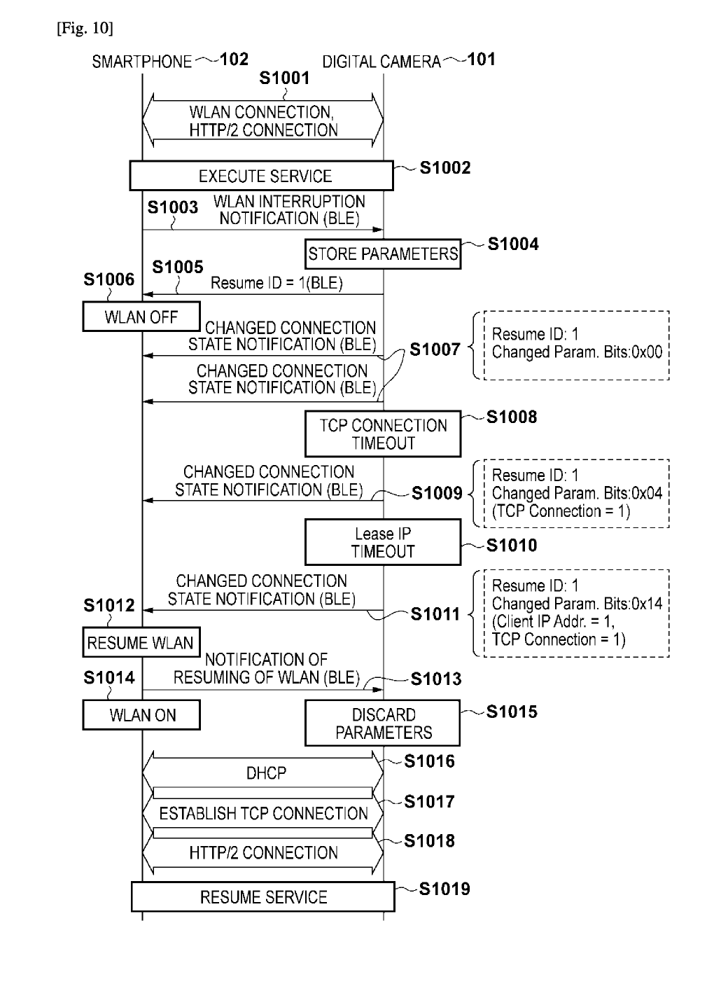

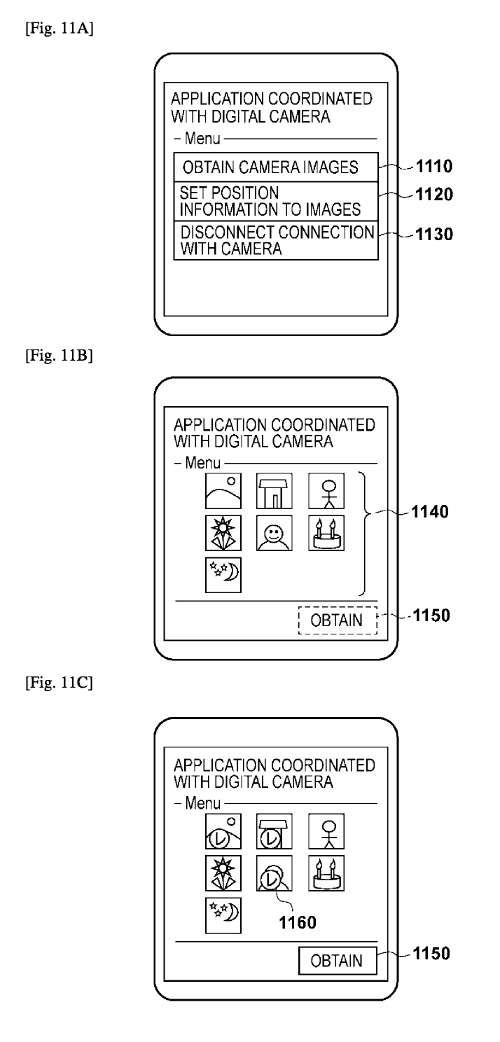

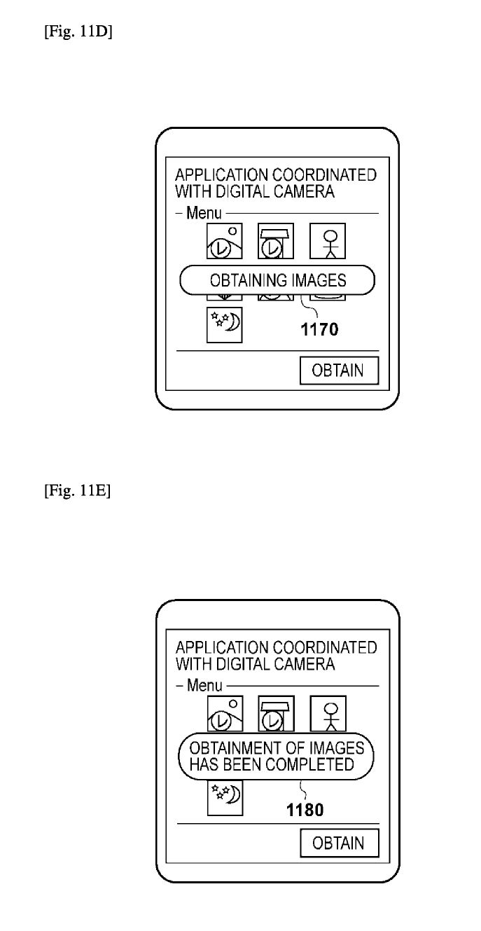

A description is now given of the flow of processing executed by the digital camera 101 and the smartphone 102 with reference to a sequence diagram of FIG. 10 and exemplary screens displayed on the smartphone 102 shown in FIGS. 11A to 11E. Although the following describes an exemplary case in which there is only one smartphone for the sake of simplicity, there may be multiple smartphones. It will be assumed that the WLAN AP communication control unit 401 of the digital camera 101 forms a wireless LAN before processing of the sequence diagram of FIG. 10 is executed. An application shown in FIGS. 11A to 11E is executed by the control unit 207 reading out a program stored in the ROM 208 of the smartphone 102. It will be assumed that, in the present embodiment, the display unit 201 is a liquid crystal display of the smartphone, and the operation accepting unit 202 is a touchscreen that detects a touch operation on the liquid crystal display.

FIG. 11A shows a menu screen that is displayed on the smartphone 102 upon activation of an application that executes the above-described processing for sharing images with the digital camera 101. This menu screen has three button regions (1110, 1120, 1130) that accept a touch operation of a user, and the function described in each button region is implemented when the button region is touched by the user. When the user touches the region 1110, the smartphone 102 starts processing for obtaining image data from the digital camera 101 (the operations illustrated in FIG. 5). When the user touches the region 1120, the smartphone 102 executes processing for notifying the digital camera 101 of current position information that is held therein via the BLE communication control unit 310. When the user touches the region 1130, the smartphone 102 ends wireless LAN communication and BLE communication with the digital camera, and ends the application.

When the user touches the menu button 1110 on the smartphone 102 in this state, the smartphone 102 executes processing from establishment of wireless LAN connection with the digital camera 101 to establishment of HTTP/2 connection with the same (step S1001). It should be noted that the processing executed here is the connection processing shown in FIG. 6. Upon completion of the connections, coordinated service processing is executed between the smartphone 102 and the digital camera 101 (step S1002). Through this coordinated service processing, the digital camera 101 transmits a list of image IDs and thumbnail images to the smartphone 102 via the wireless LAN. Thereafter, the coordinated service unit 340 of the smartphone 102 displays thumbnail images shown in FIG. 11B. Upon completion of display of the thumbnail images, the smartphone 102 transmits a notification indicating that wireless LAN communication will be interrupted to the digital camera 101 via BLE (step S1003). It should be noted that the smartphone 102 may give notice of interruption of wireless LAN communication without waiting for the thumbnail images to be displayed after the reception of data of the thumbnail images has ended.

Thumbnail images 1140 and an image obtainment button 1150 are presented on a screen of FIG. 11B displayed on the smartphone 102. The image obtainment button 1150 is a button for obtaining, from the digital camera 101, actual image data corresponding to thumbnail images 1140 that have been touched, hence selected, by the user. It should be noted that, in a state where the user has not selected the images yet as shown in FIG. 11B, the image obtainment button 1150 is inactivated.

Upon receiving the notification of interruption of wireless LAN communication, the digital camera 101 stores the communication parameters that have been shared with the smartphone 102 (step S1004), and notifies the smartphone 102 of a corresponding resume ID assigned number “1” via BLE (step S1005). Upon receiving the resume ID, the smartphone 102 stops the wireless LAN communication function (step S1006). While the wireless LAN communication function is being stopped, the smartphone 102 accepts user's selections of images to be obtained via the displayed screen shown in FIG. 11B. When the user touches some of the thumbnail images 1140 on the displayed screen shown in FIG. 11B, the touched thumbnail images are placed in a selected state with a check mark 1160 displayed thereon, as shown in FIG. 11C. In such a state where one or more images are in a selected state, the image obtainment button 1150 is activated.

While the user is selecting the images, the smartphone 102 does not perform wireless LAN communication, but the digital camera 101 transmits thereto a changed connection state notification via BLE (step S1007). Specifically, the digital camera 101 transmits a changed state notification packet in which only one state 910 with resume ID=1 and CPB=0 is designated, because at this point, there is one partner apparatus in which wireless LAN communication is being interrupted, and all of the shared parameters are valid.

Thereafter, when TCP connection for communication with the smartphone 102 is disconnected due to a timeout (step S1008), the digital camera 101 transmits a changed connection state notification packet in which resume ID=1 and CPB=0x04 are designated (step S1009). It should be noted that CPB =0x04 indicates that only the state or parameter related to TCP connection has been changed or inactivated. At this time, the smartphone 102 stores and manages the change or inactivation of at least one of the shared parameter and the connection state related to TCP connection.

If the digital camera 101 receives a notification of interruption of wireless LAN communication from the smartphone 103 in addition to the smartphone 102, it transmits a changed state notification packet that additionally contains a state 910 related to the smartphone 103. That is to say, this single changed state notification packet contains a state 910 with resume ID=1 for the smartphone 102, as well as a state 910 with resume ID=2 for the smartphone 103. In this case, each of the smartphones 102 and 103 extracts a state 910 corresponding to its own resume ID from the broadcast changed state notification packet, and determines whether the shared parameters and the communication state have been changed or inactivated.

Thereafter, the lease duration of the IP address that has been leased by the digital camera 101 to the smartphone 102 times out (step S1010). The digital camera 101 then transmits a changed connection state notification packet in which CPB=0x14 is designated in correspondence with resume ID=1 (step S1011). It should be noted that CPB=0x14 indicates that the state or parameter related to TCP connection and the IP address of the smartphone 102 have been changed or inactivated.

When the user touches the image obtainment button 1150 while one or more images are selected as shown in FIG. 11C, the coordinated service unit 340 starts processing for obtaining actual image data of the selected images from the digital camera 101, and displays a screen of FIG. 11D. At this time, the smartphone 102 decides to resume wireless LAN communication (step S1012), and transmits a notification of resuming of wireless LAN communication to the digital camera 101 (step S1013).

Once the smartphone 102 has transmitted the resume notification, it activates the wireless LAN communication function (step S1014). Upon receiving the resume notification, the digital camera 101 discards the communication parameters that have been stored in the storage unit 203 in relation to the smartphone 102 (resume ID=1) (step S1015). Then, the digital camera 101 and the smartphone 102 execute processing for sharing information related to the IP address and TCP connection for which the notification of change or inactivation was transmitted using the CPB in step S1011. The digital camera 101 and smartphone 102 also executes processing for sharing necessary information in accordance with the change or inactivation of the communication parameters and the like. That is to say, an IP address is obtained using DHCP (step S1016), TCP connection is established (step S1017), and processing for re-connection of a session and a stream based on HTTP/2 is executed (step S1018).

Thereafter, the smartphone 102 resumes coordinated service processing using the wireless LAN with the digital camera 101 (step S1019). In the state of FIG. 11D, the smartphone 102 obtains actual image data via the wireless LAN. Upon completion of obtainment of the actual image data, the smartphone 102 displays a message shown in FIG. 11E indicating the completion of obtainment of images for a certain period of time, and then returns to the displayed screen shown in FIG. 11A. In a case where the communication parameters and the communication state have not been changed, the processes of steps S1016 to S1018 are not executed, and the service is resumed after the smartphone 102 turns on the wireless LAN communication function and the digital camera 101 discards the parameters.

As described above, when interrupting wireless LAN communication, a communication apparatus according to the present embodiment stores shared parameters and a communication state at that point both in itself and in a partner apparatus, and then turns off the wireless LAN function. Thereafter, the communication apparatus receives, from the partner apparatus, a broadcast message indicating whether the shared parameters and the communication state have been changed, that is to say, whether information thereof is valid, and re-sets the changed or inactivated parameters and communication state. Specifically, the parameters and the like that have not been changed since the interruption of wireless LAN communication are used as-is, whereas the parameters and the like that have been changed or inactivated after the interruption are re-set. This can not only simplify re-set processing compared to a case in which all of the parameters and the like are re-set, but also prevent the occurrence of, for example, a network failure caused by re-connection processing using the parameters and the like that have been partially changed or inactivated.

Furthermore, as a broadcast message is transmitted via BLE as a notification indicating whether the parameters and the like are valid, one-time transmission of the notification message can give notice of the validity of the parameters and the like, even under a circumstance in which a plurality of communication apparatuses have interrupted wireless LAN communication. This can reduce power consumption required to give notice of the validity of the parameters and the like.

### Second Embodiment

The first embodiment has described a case in which a broadcast message via BLE is used to give notice of a change in shared parameters. On the other hand, the present embodiment gives notice of shared parameters by establishing BLE connection between communication apparatuses and transmitting a message over the BLE connection.

(Processing of Smartphone)

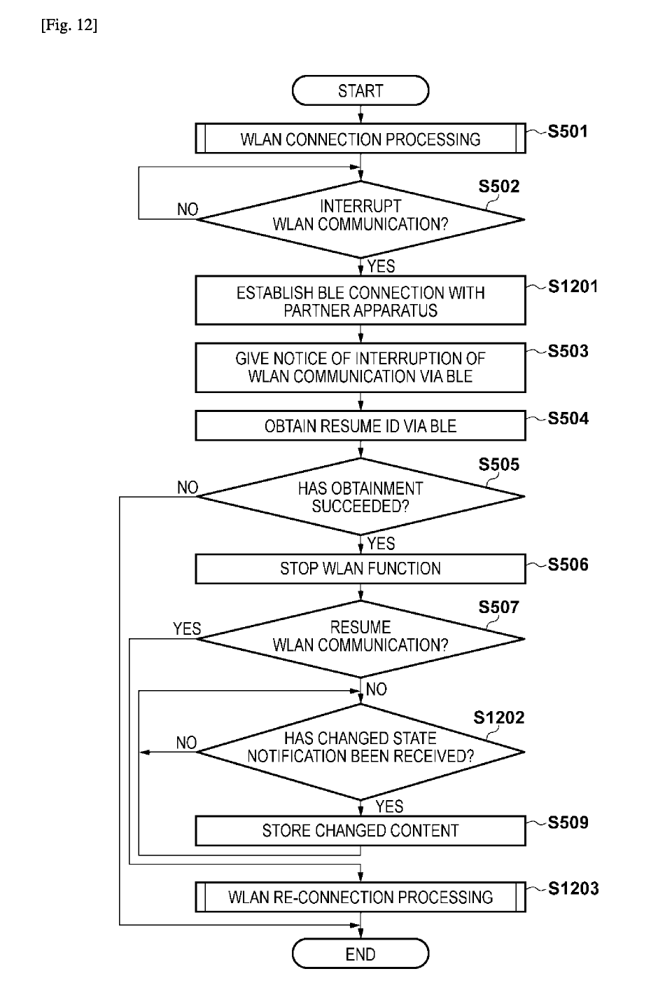

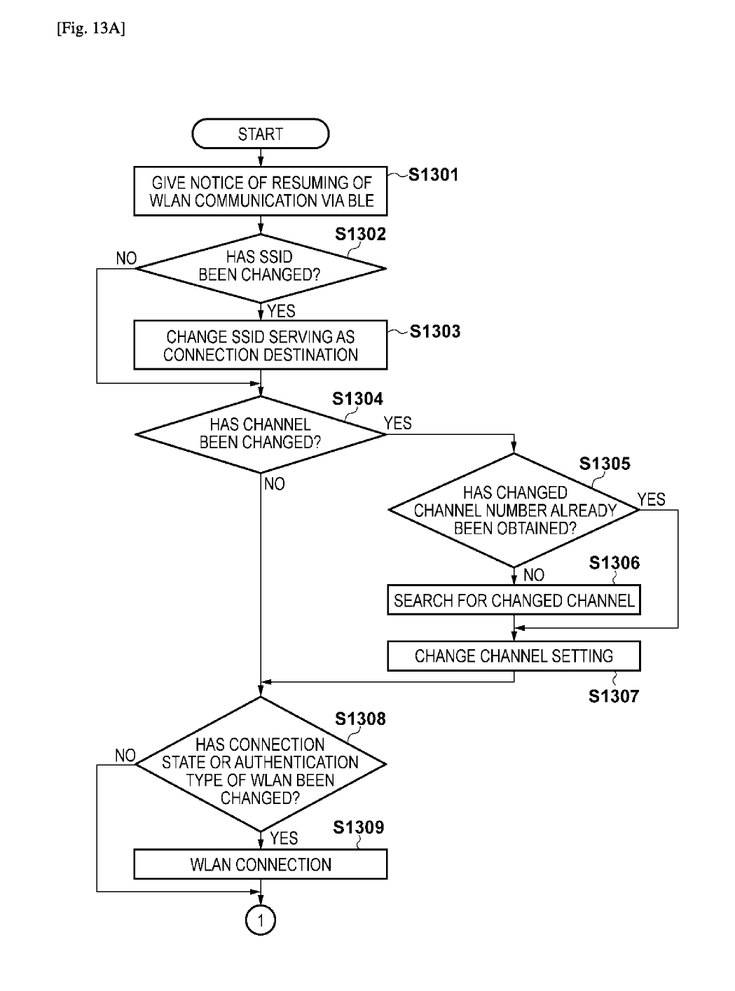

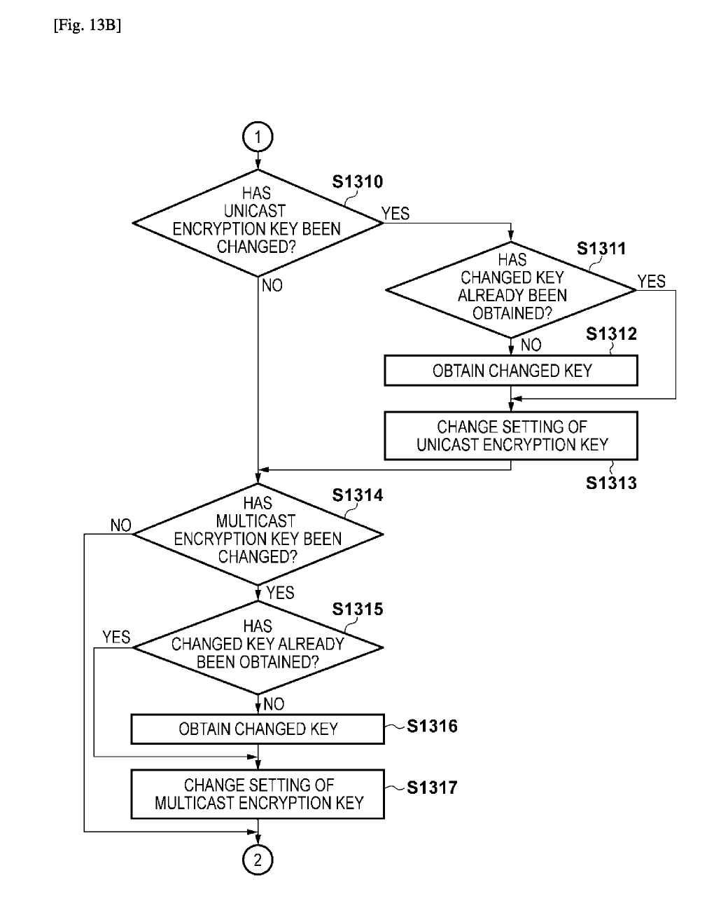

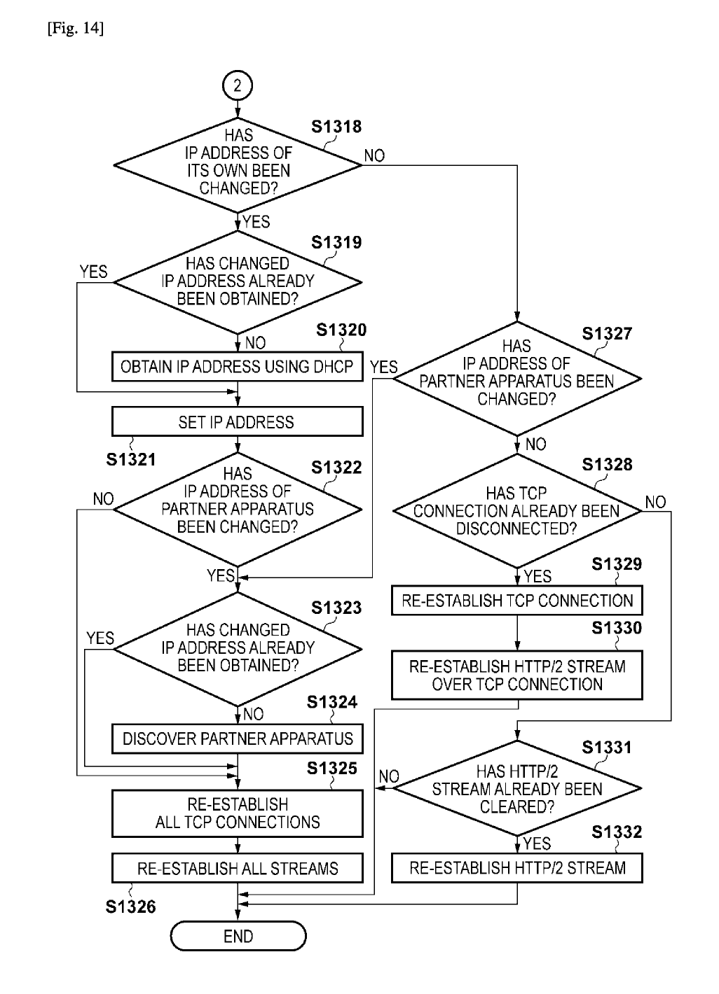

The flow of processing executed by the smartphone 102 or 103 according to the present embodiment will now be described with reference to flowcharts of FIGS. 12 to 14. FIG. 12 shows a processing flow for a case in which the smartphone 102 or 103 establishes connection via a wireless LAN, stops communication via the wireless LAN, and then resumes the communication. FIGS. 13A, 13B and 14 show the flow of wireless LAN re-connection processing. It should be noted that the flowcharts of FIGS. 12 to 14 are realized by, for example, the control unit 207 reading out and executing programs stored in the ROM 208 in the smartphone 102 or 103. In the following description, out of the smartphones 102 and 103, the smartphone 102 executes processing.

The processes of FIG. 12 are basically similar to the processes of FIG. 5. Therefore, with regard to FIG. 12, the processes that are similar to the processes of FIG. 5 are given the same reference numerals thereas so as to omit a description thereof, and different processes will be described in detail. In the present embodiment, if the smartphone 102 determines to interrupt wireless LAN communication (YES of step S502), it establishes BLE connection with a partner apparatus (digital camera 101) (step S1201). Then, in a time period that follows obtainment of a resume ID and precedes resuming of wireless LAN communication (YES of step S505, NO of step S507), the smartphone 102 receives a changed state notification via BLE unicast (step S1202).

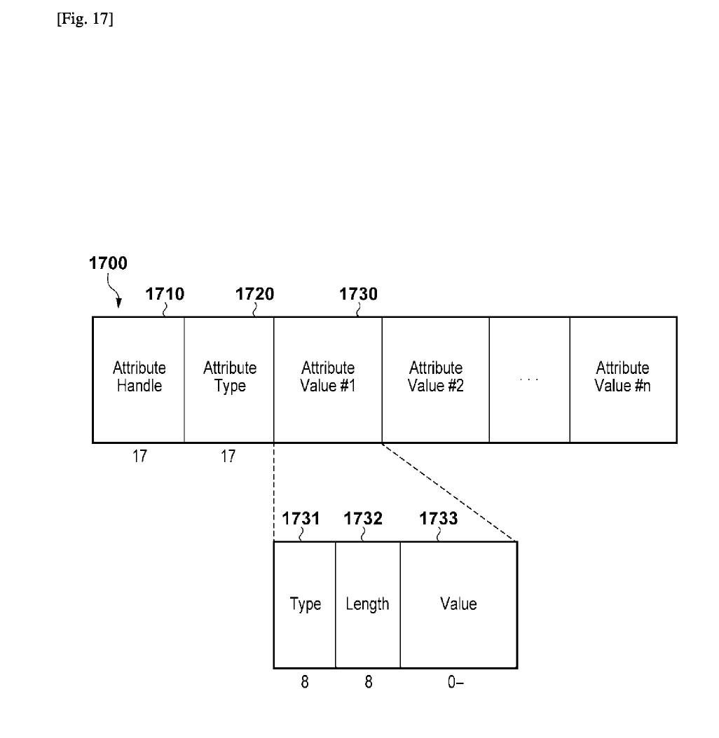

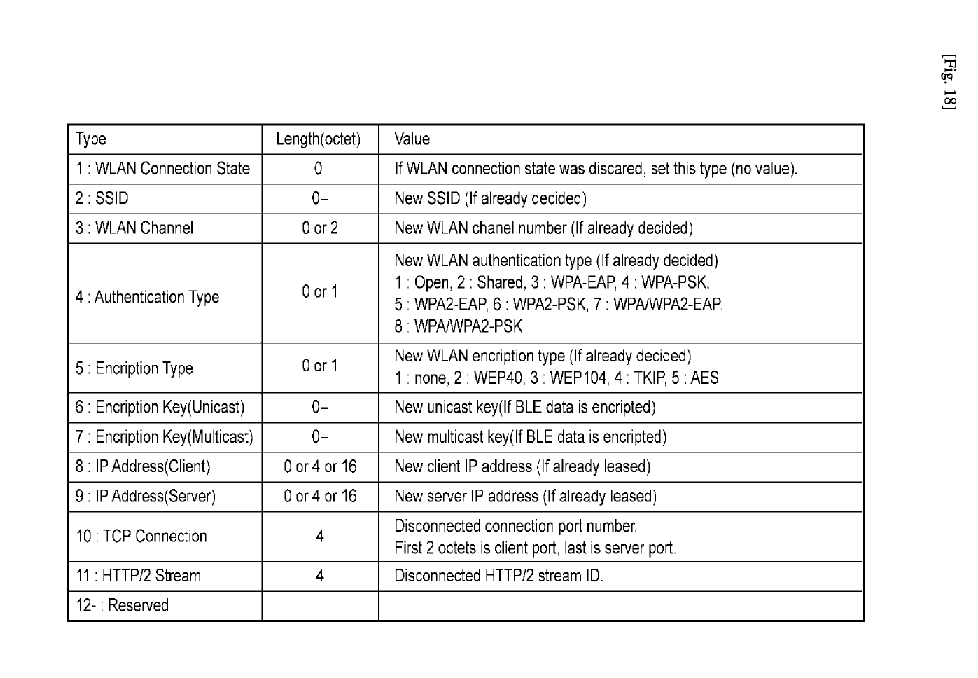

Communication parameters and the like that can be presented by such a unicast notification include, for example, at least one of a network identifier, a channel number to be used (frequency information to be used), a group encryption key, and an encryption key for unicast communication or multicast communication with the partner apparatus. These communication parameters and the like also include, for example, information indicating a communication state, such as information of the IP addresses of its own and the partner apparatus, a connected TCP session, or a session and a stream based on HTTP/2 . A structure of a unicast changed connection state packet will now be described with reference to FIG. 17. It should be noted that the exemplary structure shown in FIG. 17 serves as an example, and other structures may be used to give notice of information similar to the information described below.

A changed connection state notification packet 1700 is a unicast message that is transmitted by the digital camera 101 to the smartphone 102 via BLE. It should be noted that this message is transmitted using the Attribute Protocol (ATT) defined in the BLE standards. The changed connection state notification packet 1700 contains an attribute handle 1710, an attribute type 1720, and one or more attribute values 1730 as data fields. Each attribute value 1730 contains a type 1731, a length 1732, and a value 1733.

The attribute handle 1710 is a two-byte integer value allocated to a corresponding attribute value. The attribute type 1720 is a two-byte value indicating the attribute type; in the changed connection state notification packet 1700, a value indicating a changed connection state is set thereas. Each attribute value 1730 (hereinafter referred to as “AVal”) is a value of an attribute of the changed connection state. The type 1731 is a two-byte value indicating the type of the changed connection state. The length 1732 is a two-byte value indicating the length of the value 1733. The value 1733 is a value set in relation to the changed connection state indicated by the type 1731.

A description is now given of the type, length, and value designated in an AVal 1730 of the changed connection state notification packet 1700 with reference to FIG. 18.

A type 1731 set to 1 indicates that wireless LAN connection with the smartphone 102 has been discarded. When the type 1731 is set to 1, the value 1733 contains no data.

A type 1731 set to 2 indicates that the network identifier (SSID) of the wireless LAN has been changed. In this case, the value 1733 contains data that designates a changed SSID if the changed SSID has already been decided, and contains no data if the changed SSID has not been decided (unknown).

A type 1731 set to 3 indicates that a channel number used in the wireless LAN (used frequency) has been changed. In this case, the value 1733 contains data that designates a changed channel number (used frequency) if the changed channel number has already been decided, and contains no data if the changed channel number has not been decided (unknown).

A type 1731 set to 4 identifies a change in the WLAN authentication type. In this case, the value 1733 contains data that designates a changed authentication type if the changed authentication type has already been decided, and contains no data if the changed authentication type has not been decided (unknown).

A type 1731 set to 5 identifies a change in the WLAN encryption type. In this case, the value 1733 contains data that designates a changed encryption type if the changed encryption type has already been decided, and contains no data if the changed encryption type has not been decided (unknown).

A type 1731 set to 6 identifies a change in an encryption key for unicast communication with a communication terminal. A type 1731 set to 7 identifies a change in an encryption key for multicast communication in the network. In these cases, the value 1733 contains data that designates a value of a changed encryption key if the changed key has already been decided, and contains no data if the changed key has not been decided (unknown).

A type 1731 set to 8 identifies a change in the IP address allocated to the communication terminal. In this case, the value 1733 contains data that designates a changed IP address if the changed IP address has already been decided, and contains no data if the changed IP address has not been decided (unknown).

A type 1731 set to 9 identifies a change in the IP address of a communication apparatus that transmitted the changed connection state notification including this information. In this case, the value 1733 contains data that designates a changed IP address if the changed IP address has already been decided, and contains no data if the changed IP address has not been decided (unknown).

A type 1731 set to 10 identifies a discarded connection state of TCP connection that was established. In this case, the value 1733 contains data that designates a client port number and a server port number of the disconnected TCP connection. A type 1731 set to 11 identifies a discarded connection state of an HTTP/2 stream that was established with the communication terminal. In this case, the value 1733 contains data that designates a number assigned to the stream ID of the disconnected HTTP/2 stream.

Returning to FIG. 12, if resuming of wireless LAN communication has been decided (YES of step S507), the smartphone 102 executes re-connection processing based on the unicast message (step S1203). The flow of this re-connection processing will now be described with reference to FIGS. 13A, 13B and 14.

When resuming the interrupted wireless LAN communication, the WLAN connection state management unit 330 first notifies the partner apparatus (digital camera 101) of resuming of wireless LAN communication via the BLE communication control unit 310 (step S1301). Subsequently, the WLAN connection state management unit 330 refers to the information stored in step S509, and either changes the setting or executes re-connection processing with respect to protocols for which shared parameters were changed after the wireless LAN communication function was stopped in step S506.

The WLAN STA communication control unit 301 determines whether the SSID of the wireless LAN generated by the digital camera 101 has been changed (step S1302). If the SSID of the wireless LAN generated by the digital camera 101 has been changed (YES of step S1302), the WLAN STA communication control unit 301 changes the network serving as a connection destination to the SSID that was stored in step S509 after the setting was changed (step S1303). On the other hand, if the SSID has not been changed, processing proceeds to step S1304.

Subsequently, the WLAN STA communication control unit 301 determines whether a channel (used frequency) of the wireless LAN has been changed (step S1304). If the channel has been changed (YES of step S1304) and the changed channel number was obtained in step S509 (YES of step S1305), the WLAN STA communication control unit 301 changes the channel number of the connection destination to the obtained number (step S1307). On the other hand, if the channel has been changed (YES of step S1304) and information of the changed channel has not been obtained (NO of step S1305), the WLAN STA communication control unit 301 scans for a channel of the wireless LAN generated by the digital camera 101 (step S1306). Thereafter, the WLAN STA communication control unit 301 changes the setting of the channel number of the connection destination, that is to say, changes the channel number of the connection destination to the channel number discovered through the search (step S1307).

Next, the WLAN STA communication control unit 301 determines whether the connection state or the authentication type of the wireless LAN has been changed (step S1308). If the connection state or the authentication type of the wireless LAN has been changed (YES of step S1308), the WLAN STA communication control unit 301 executes processing for connecting to the wireless LAN generated by the digital camera 101 (step S1309).

Thereafter, the WLAN STA communication control unit 301 determines whether an encryption key for unicast communication has been changed (step S1310). If the encryption key for unicast communication has been changed (YES of step S1310) and the changed key was obtained in step S509 (YES of step S1311), the WLAN STA communication control unit 301 changes an encryption key to be used to the obtained key (step S1313). On the other hand, if the encryption key for unicast communication has been changed (YES of step S1310) and the changed key has not been obtained (NO of step S1311), the WLAN STA communication control unit 301 executes processing for exchanging a key with the digital camera 101 (step S1312). It should be noted that, in this key exchange processing, for example, four-way handshake defined in the IEEE 802.11 standards is carried out. The WLAN STA communication control unit 301 then changes the setting of the key to be used in unicast communication with the digital camera 101 via the wireless LAN, that is to say, changes the key to the key obtained in step S1312 (step S1313).

Thereafter, the WLAN STA communication control unit 301 determines whether an encryption key for multicast communication has been changed (step S1314). If the encryption key for multicast communication has been changed (YES of step S1314) and the changed key was obtained in step S509 (YES of step S1315), the WLAN STA communication control unit 301 changes an encryption key to be used to the obtained key (step S1316). On the other hand, if the encryption key for multicast communication has been changed (YES of step S1314) and the changed key has not been obtained (NO of step S1315), the WLAN STA communication control unit 301 executes processing for exchanging a key with the digital camera 101 (step S1316). It should be noted that, in this key exchange processing, for example, two-way handshake defined in the IEEE 802.11 standards is carried out. The WLAN STA communication control unit 301 then changes the setting of the key to be used in multicast communication with the digital camera 101 via the wireless LAN, that is to say, changes the key to the key obtained in step S1316 (step S1317).

Turning to FIG. 14, the WLAN STA communication control unit 301 determines whether the IP address of the smartphone 102 has been changed (step S1318). If the IP address of the smartphone 102 has been changed (YES of step S1318), the smartphone 102 executes re-connection processing for the IP layer and above. At this time, if the changed IP address was not obtained in step S509 (NO of step S1319), the DHCP client processing unit 302 obtains an IP address to be used by the smartphone 102 from the digital camera 101 using DHCP (step S1320). Then, the IP communication unit 303 sets the IP address obtained in step S1320 as the IP address of the smartphone 102 (step S1321). On the other hand, if the changed IP address was obtained in step S509 (YES of step S1319), the IP communication unit 303 sets the IP address obtained in step S509 as the IP address of the smartphone 102 (step S1321).

Subsequently, the WLAN STA communication control unit 301 determines whether the IP address of the partner apparatus (digital camera 101) has been changed (step S1322). The WLAN STA communication control unit 301 similarly determines whether the IP address of the digital camera 101 has been changed (step S1327) also in a case where the IP address of the smartphone 102 has not been changed (NO of step S1318). If the IP address of the digital camera 101 has been changed (YES of step S1322 or S1327) and the changed IP address has not been obtained (NO of step S1323), the coordinated service unit 340 obtains an IP address of the digital camera 101 (step S1324). It should be noted that this processing for searching for and obtaining the IP address of the digital camera 101 is executed, for example, using SSDP.

If the IP address of at least one of the digital camera 101 and the smartphone 102 has been changed, re-establishment of TCP connection and re-establishment of a session and a stream based on HTTP/2 are carried out in accordance with the change in the IP address. Therefore, after step S1324, the TCP client processing unit 304 and the HTTP/2 client processing unit 305 execute processing for re-establishing all of the TCP connections and all of the HTTP/2 streams that were established with the digital camera 101 (steps S1325 and S1326).

If the IP addresses of the digital camera 101 and the smartphone 102 have not been changed (NO of steps S1318 and S1327), the WLAN connection state management unit 330 determines whether there is TCP connection with the digital camera 101 that has been disconnected (step S1328). If there is TCP connection that has been disconnected (YES of step S1328), the TCP client processing unit 304 executes processing for re-establishing TCP connection to a disconnected port number (step S1329). The HTTP/2 client processing unit 305 accordingly executes processing for re-establishing an HTTP/2 stream that was in operation over the disconnected TCP connection (step S1330).

On the other hand, if there is no TCP connection that has been disconnected (NO of step S1328), the WLAN connection state management unit 330 determines whether there is an HTTP/2 stream with the digital camera 101 that has been disconnected (step S1331). If there is an HTTP/2 stream that has been disconnected (YES of step S1331), the HTTP/2 client processing unit 305 executes processing for re-establishing the disconnected stream (step S1332).

It should be noted that, if the processing of FIGS. 13A, 13B and 14 has failed, the WLAN connection state management unit 330 determines that the wireless LAN reconnection processing has failed, and stops the wireless LAN communication function again (not shown).

(Processing of Digital Camera)

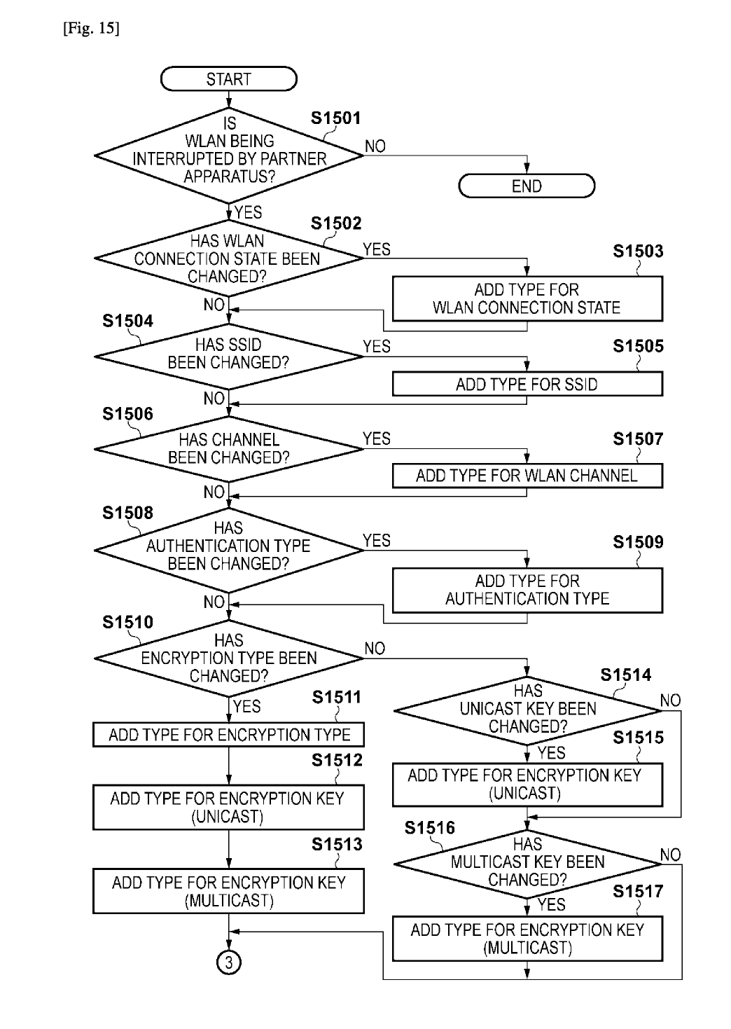

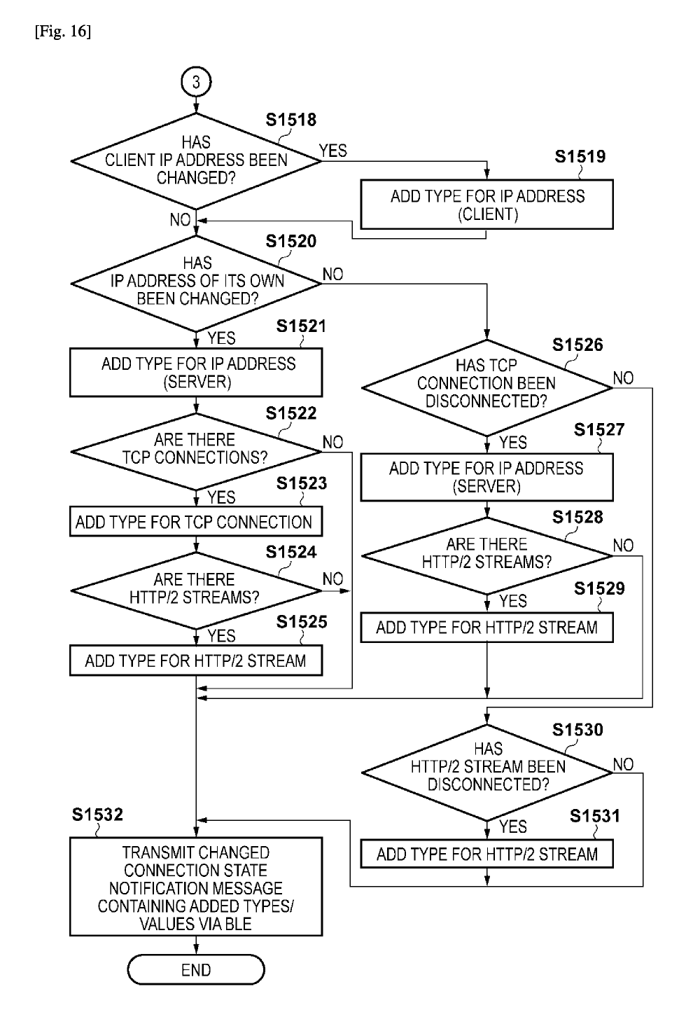

A description is now given of the flow of processing executed by the digital camera 101 according to the present embodiment using the flowcharts of FIGS. 15 and 16. In the present embodiment also, when the digital camera 101 receives a notification of interruption of wireless LAN communication from a partner apparatus, it stores, into the storage unit 203, communication parameters and the like for wireless LAN communication that are shared with the partner apparatus that transmitted the notification (smartphone 102). Once the digital camera 101 has stored the communication parameters, it issues and allocates a resume ID corresponding to the communication parameters, and notifies the partner apparatus of the resume ID via BLE.

FIGS. 15 and 16 are flowcharts showing the flow of processing executed by the connection partner apparatus management unit 420 upon detection of a change in communication parameters. In this processing, the connection partner apparatus management unit 420 searches for changed communication parameters, and transmits a changed state notification message containing these parameters to the smartphone 102 via BLE.

Upon detecting a change in communication parameters, the connection partner apparatus management unit 420 checks whether wireless LAN communication is being interrupted by the partner apparatus (smartphone 102) (step S1501). If wireless LAN communication is not being interrupted by the smartphone 102 (NO of step S1501), the connection partner apparatus management unit 420 ends the present processing. If wireless LAN communication is being interrupted by the smartphone 102 (YES of step S1501), the connection partner apparatus management unit 420 compares the stored communication parameters with the changed communication parameters, and generates data of a changed connection state notification packet 1700 as follows.

First, the connection partner apparatus management unit 420 determines whether wireless LAN connection with the smartphone 102 has been disconnected (step S1502). If wireless LAN connection with the smartphone 102 has been disconnected (YES of step S1502), the connection partner apparatus management unit 420 adds, to the packet, an AVal 1730 containing a type 1731 set to 1 (step S1503).

Next, the connection partner apparatus management unit 420 determines whether the SSID has been changed (step S1504). If the SSID has been changed (YES of step S1504), the connection partner apparatus management unit 420 adds, to the packet, an AVal 1730 containing a type 1731 set to 2 (step S1505). If the changed SSID has already been decided, the connection partner apparatus management unit 420 also includes the changed SSID in a value 1733.

Then, the connection partner apparatus management unit 420 determines whether a channel (frequency) used in the wireless LAN has been changed (step S1506). If the channel has been changed (YES of step S1506), the connection partner apparatus management unit 420 adds, to the packet, an AVal 1730 containing a type 1731 set to 3 (step S1507). If the changed channel number has already been decided, the connection partner apparatus management unit 420 also includes the changed communication channel number in a value 1733.

Next, the connection partner apparatus management unit 420 determines whether the authentication type of the wireless LAN has been changed (step S1508). If the authentication type of the wireless LAN has been changed (YES of step S1508), the connection partner apparatus management unit 420 adds, to the packet, an AVal 1730 containing a type 1731 set to 4 (step S1509). If the changed authentication type has already been decided, the connection partner apparatus management unit 420 also includes the changed authentication type in a value 1733.

Then, the connection partner apparatus management unit 420 determines whether the encryption type of the wireless LAN has been changed (step S1510). If the encryption type of the wireless LAN has been changed (YES of step S1510), the connection partner apparatus management unit 420 first adds, to the packet, an AVal 1730 containing a type 1731 set to 5 (step S1511). In this case, the stored unicast key and multicast key are accordingly inactivated. Therefore, the connection partner apparatus management unit 420 adds, to the packet, an AVal 1730 containing a type 1731 set to 6 and an AVal 1730 containing a type 1731 set to 7 (steps S1512 and S1513). If the changed encryption type, unicast key, and multicast key have already been decided, the connection partner apparatus management unit 420 also designates the changed values in the fields of values 1733 in the corresponding AVals 1730.

On the other hand, if the encryption type of the wireless LAN has not been changed (NO of step S1510), the connection partner apparatus management unit 420 subsequently checks whether encryption keys for wireless LAN communication have been changed (steps S1514 and S1516). If a unicast key for communication with the smartphone 102 has been changed (YES of step S1514), the connection partner apparatus management unit 420 adds, to the packet, an AVal 1730 containing a type 1731 set to 6 (step S1515). If the changed unicast key has already been decided, the connection partner apparatus management unit 420 also includes information designating the changed key in a value 1733. If a multicast key for the wireless LAN has been changed (YES of step S1516), the connection partner apparatus management unit 420 adds, to the packet, an AVa1 1730 containing a type 1731 set to 7 (step S1517). If the changed multicast key has already been decided, the connection partner apparatus management unit 420 also includes information designating the changed key in a value 1733.

Turning to FIG. 16, the connection partner apparatus management unit 420 determines whether the IP address allocated to the smartphone 102 has been changed (step S1518). If the IP address allocated to the smartphone 102 has been changed (YES of step S1518), the connection partner apparatus management unit 420 adds, to the packet, an AVal 1730 containing a type 1731 set to 8 (step S1519). If the changed IP address has already been decided, the connection partner apparatus management unit 420 also includes a value indicating the changed IP address in a value 1733.

Subsequently, the connection partner apparatus management unit 420 determines whether the IP address of its own (digital camera 101) has been changed (step S1520). If the IP address of the digital camera 101 has been changed (YES of step S1520), the connection partner apparatus management unit 420 adds, to the packet, an AVa1 1730 containing a type 1731 set to 9 (step S1521). In this case, the connection partner apparatus management unit 420 also checks whether there are TCP connections that were established with the smartphone 102 (step S1522). If there are TCP connections that were established (YES of step S1522), the connection partner apparatus management unit 420 adds, to the packet, as many AVals 1730 containing a type 1731 set to 10 as the number of the connections (step S1523). The connection partner apparatus management unit 420 further checks whether there are HTTP/2 streams that were established with the smartphone 102 (step S1524). If there are such streams (YES of step S1524), the connection partner apparatus management unit 420 adds, to the packet, as many AVals 1730 containing a type 1731 set to 11 as the number of the streams (step S1525).

On the other hand, if the IP address of the digital camera 101 has not been changed (NO of step S1520), the connection partner apparatus management unit 420 checks whether there is TCP connection with the smartphone 102 that has been disconnected (step S1526). If there is TCP connection that has been disconnected (YES of step S1526), the connection partner apparatus management unit 420 adds, to the packet, an AVal 1730 containing a type 1731 set to 10 (step S1527). In this case, the connection partner apparatus management unit 420 also checks whether there are HTTP/2 streams that were established over the TCP connection (step S1528). If there are such streams (YES of step S1528), the connection partner apparatus management unit 420 adds, to the packet, as many AVals 1730 containing a type 1731 set to 11 as the number of the streams (step S1529).

On the other hand, if there is no TCP connection that has been disconnected (NO of step S1526), the connection partner apparatus management unit 420 checks whether there is an HTTP/2 stream with the smartphone 102 that has been disconnected (step S1530). If there is an HTTP/2 stream that has been disconnected (YES of step S1530), the connection partner apparatus management unit 420 adds, to the packet, an AVal 1730 containing a type 1731 set to 11 (step S1531).

Upon completion of the above-described processing, the connection partner apparatus management unit 420 transmits a changed state notification message containing the generated data to the smartphone 102 via the BLE communication control unit 410 (step S1532).

(Flow of Processing in Wireless Communication System)

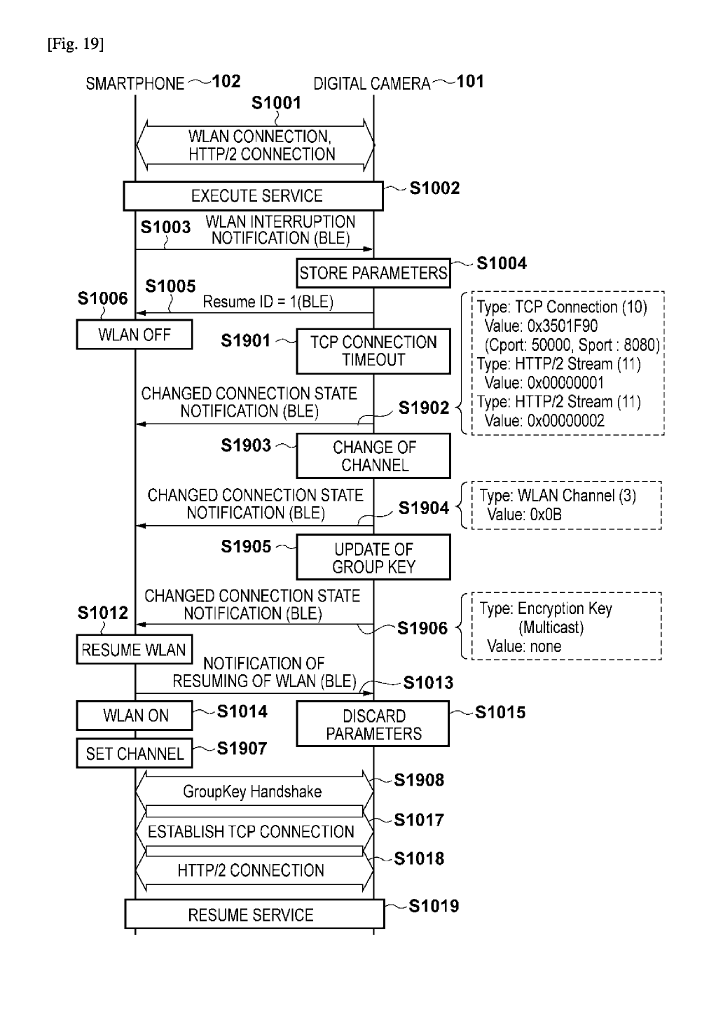

A description is now given of the flow of processing executed by the digital camera 101 and the smartphone 102 with reference to FIG. 19. It will be assumed that the WLAN AP communication control unit 401 of the digital camera 101 forms a wireless LAN before processing of a sequence diagram of FIG. 19 is executed. The processes that are similar to the processes of FIG. 10 are given the same reference numerals thereas so as to omit a description thereof.

The processes that are executed from when the processing is started to when the smartphone 102 turns off the wireless LAN communication function (steps S1001 to S1006) are similar to the processes pertaining to the case of FIG. 10, and thus a description thereof is omitted. Then, when TCP connection for communication with the smartphone 102 is disconnected due to a timeout (step S1901), the digital camera 101 transmits a changed state notification message to the smartphone 102 (step S1902). It will be assumed that the TCP port number of the smartphone 102 and the TCP port number of the digital camera 101 in the disconnected TCP connection are respectively 50000 and 8080, for example. It will also be assumed that HTTP/2 streams having IDs of 1 and 2 were established over this TCP connection. In this case, the following are set in a message of step S1902: an attribute value with a type 1731 set to 10 and an AVal 1730 set to 0xC3501F90, an attribute value with a type 1731 set to 11 and an AVal 1730 set to 1, and an attribute value with a type 1731 set to 11 and an AVal 1730 set to 2.

When a channel of the wireless LAN generated by the digital camera 101 has been changed (step S1903), the digital camera 101 transmits the changed state notification message to the smartphone 102 again (step S1904). It will be assumed that the channel number of the wireless LAN has been changed to 11 therein. In this case, the following is set in the message of step S1904: an attribute value with a type 1731 set to 3, and AVal 1730=11 (0x0B).

When a group key of the wireless LAN generated by the digital camera 101 has been changed (step S1905), the digital camera 101 transmits the changed state notification message to the smartphone 102 again (step S1906). It will be assumed that a value of the changed key has not been defined yet. Accordingly, the following is set in the message of step S1906: an attribute value with a type 1731 set to 7, and AVal 1730=none.

Subsequently, once the smartphone 102 has resumed the wireless LAN communication function (steps S1012 to S1015), the setting of the channel number used in the wireless LAN is changed, that is to say, the channel number used in the wireless LAN is changed to the channel number “11” received in step S1904 (step S1907). Thereafter, the smartphone 102 executes processing for exchanging a group key (step S1908), establishes TCP connection (step S1017), and executes processing for re-establishing an HTTP/2 stream (step S1018). The smartphone 102 then resumes coordinated service processing with the digital camera 101 (step S1019).

As described above, the present embodiment gives notice of a change in shared parameters using BLE connection established between communication apparatuses. Furthermore, in the present embodiment, a notification is transmitted/received through unicast transmission via BLE, and thus additional information, such as the changed channel and IP address, is transmitted/received. This eliminates the need to execute processing for sharing at least a part of shared parameters that have been changed when resuming wireless LAN communication, thereby further reducing a processing time period required in connection. For instance, referring to the example of FIG. 19, even though the digital camera 101 has changed the channel used in the wireless LAN, the smartphone 102 need not execute processing for searching for the channel at the time of re-connection.

Although the above has described exemplary embodiments of the present invention, it is apparent that the present invention be by no means limited to these embodiments, and can be embodied with modifications within a scope in which the concept of the present invention is unchanged. For example, although the communication functions of communication apparatuses are a wireless LAN and BLE in the above-described embodiments, other communication functions may be used. For example, Bluetooth (registered trademark) 3.0, Zigbee (registered trademark), the Radio Frequency for Consumer Electronics (RF4CE), Wireless USB, and the like may be used as the communication functions.

Although the protocols managed between communication apparatuses are restricted to particular protocols including IP, TCP, and HTTP/2 in the above-described embodiments, the protocols are not limited in the present invention. That is to say, the techniques according to the above-described embodiments are applicable to protocols for sharing some sort of parameter and state between communication apparatuses; for example, the techniques according to the above-described embodiments are applicable to, among others, unique application protocols that operate based on TCP. In addition, the above-described embodiments may be applied to only a part of the protocols that have been described as examples. That is to say, for example, the techniques according to the above-described embodiments may be applied to TCP and HTTP/2 , and may not be applied to IP.

Although the formats of a message used to give notice of a change or inactivation of shared parameters have been exemplarily described in the above embodiments, notification may be made in any manner within a scope in which the concept of giving notice of a change in shared parameters is unchanged.

Although the digital camera 101 plays a leading role in notifying the smartphone 102 of a change in shared parameters in the above-described embodiments, other techniques may be used. For example, the smartphone 102 may make an inquiry to the digital camera 101 about the change through polling processing, and receive the above-described notification message in response to the inquiry.

Although the digital camera 101 transmits a changed state notification message via BLE only while there is a smartphone 102 in which wireless LAN communication is being interrupted in the above-described embodiments, no limitation is intended in this regard. That is to say, the digital camera 101 may, for example, transmit the notification message regardless of the existence of a smartphone 102 in which wireless LAN communication is being interrupted.

Although the above embodiments have described an example in which the digital camera 101 stops managing a change in shared parameters by removing a resume ID when it receives a notification of resuming of wireless LAN communication from the smartphone 102, no limitation is intended in this regard. The digital camera 101 may stop managing a change in shared parameters by removing a resume ID when, for example, BLE communication with the smartphone 102 is disabled. The digital camera 101 may also stop managing a change in shared parameters by removing a resume ID when it receives, from the smartphone 102, a notification message indicating that wireless LAN communication will not be resumed.

According to the above-described embodiments, when a communication apparatus (smartphone 102) performs re-connection of wireless LAN communication with another communication apparatus (digital camera 101), processing for communication protocols that were operating via a wireless LAN can be appropriately resumed. That is to say, processing for communication protocols that can be continued while remaining in the pre-disconnection state is continued as-is, whereas processing for communication protocols that cannot be continued while remaining in the pre-disconnection state can be re-executed. This can prevent the occurrence of unnecessary communication traffic and triggering of a network failure, and reduce a processing time period required in re-connection. In addition, a communication apparatus (digital camera 101) can change an IP address, a TCP connection state, and the like that have been shared with another communication apparatus (smartphone 102) while the wireless LAN communication function is being stopped by another communication apparatus. In this way, limited communication resources can be efficiently used. For example, in a case where other communication apparatuses exist in large numbers, a shortage of IP addresses and sockets can be prevented. Although a digital camera and a smartphone have been used as examples of communication apparatuses in the above-described embodiments, the above-described embodiments are applicable also to other apparatuses, such as PCs, printers, digital home electronics, and mobile terminals.

The present invention enables a communication apparatus that stops and resumes a communication function to execute appropriate communication resuming processing in accordance with the state at the time of stopping communication and the state at the time of resuming communication.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-204215, filed Oct. 2, 2014, which is hereby incorporated by reference herein in its entirety.

1.-24. (canceled)

25. A communication apparatus, comprising:
a storage unit configured to keep information for wireless LAN communication compliant with IEEE 802.11 standards stored therein, even after the wireless LAN communication with a partner apparatus involved with communication is stopped, the information having been obtained from the partner apparatus;
a determination unit configured to determine whether the information stored in the storage unit is valid through Bluetooth communication with the partner apparatus; and
a communication unit configured to resume the wireless LAN communication with the partner apparatus
upon re-obtaining the information for the wireless LAN communication from the partner apparatus in a case where at least a part of the information stored in the storage unit is not valid, and
without re-obtaining the information for the wireless LAN communication from the partner apparatus in a case where the information stored in the storage unit is valid.

26. A communication apparatus, comprising:
a storage unit configured to store information for wireless LAN communication compliant with IEEE 802.11 standards, the information having been provided to a partner apparatus involved with communication; and
a notification unit configured to, in a case where at least a part of the information stored in the storage unit has been changed or inactivated, notify the partner apparatus of the change or the inactivation of the at least part of the information through Bluetooth communication.

27. A communication apparatus with a first communication function and a second communication function that has lower power consumption than the first communication function, the communication apparatus comprising:
a storage unit configured to keep information for communication based on the first communication function stored therein, even after the communication based on the first communication function with a partner apparatus involved with communication is stopped, the information having been obtained from the partner apparatus;
a determination unit configured to determine whether the information stored in the storage unit is valid through communication based on the second communication function with the partner apparatus; and
a communication unit configured to resume the communication based on the first communication function with the partner apparatus
upon re-obtaining the information for the communication based on the first communication function from the partner apparatus in a case where at least a part of the information stored in the storage unit is not valid, and
without re-obtaining the information for the communication based on the first communication function from the partner apparatus in a case where the information stored in the storage unit is valid.

28. The communication apparatus according to claim 27, wherein
the information for the communication based on the first communication function is obtained from the partner apparatus using the second communication function.

29. The communication apparatus according to claim 27, wherein
the information includes parameters used in the communication based on the first communication function, and
the determination unit determines that, out of the information, a part related to the parameters is not valid in a case where the communication apparatus is notified of a change or inactivation of the parameters through the communication based on the second communication function.

30. The communication apparatus according to claim 29, wherein
the parameters include at least one of a network identifier, information indicating a used channel, an encryption type, an encryption key, an authentication type, an address of the communication apparatus, and an address of the partner apparatus.

31. The communication apparatus according to claim 27, wherein
the information includes information indicating a communication state of the communication based on the first communication function, and
the determination unit determines that, out of the information, a part related to the communication state is not valid in a case where the communication apparatus is notified of a change or inactivation of the communication state through the communication based on the second communication function.

32. The communication apparatus according to claim 31, wherein
the communication state includes information related to at least one of connection, a session, and a stream.

33. The communication apparatus according to claim 27, wherein
the determination unit determines whether the information stored in the storage unit is valid based on a message that is broadcast by the partner apparatus using the second communication function.

34. The communication apparatus according to claim 27, wherein
the determination unit determines whether the information stored in the storage unit is valid based on a unicast message that is transmitted by the partner apparatus using the second communication function.

35. The communication apparatus according to claim 34, wherein
the transmitted unicast message contains information identifying the at least part that has been changed or inactivated out of the information, or contains changed information.

36. A communication apparatus with a first communication function and a second communication function that has lower power consumption than the first communication function, the communication apparatus comprising:
a storage unit configured to store information for communication based on the first communication function, the information having been provided to a partner apparatus involved with communication; and
a notification unit configured to, in a case where at least a part of the information stored in the storage unit has been changed or inactivated, notify the partner apparatus of the change or the inactivation of the at least part of the information through communication based on the second communication function.

37. The communication apparatus according to claim 36, wherein
the storage unit stores the information at a time when the partner apparatus stops the communication based on the first communication function with the communication apparatus.

38. The communication apparatus according to claim 36, wherein
the notification unit performs the notification after the partner apparatus has stopped the communication based on the first communication function with the communication apparatus.

39. The communication apparatus according to claim 38, wherein
the notification unit stops the notification after the partner apparatus has resumed the communication based on the first communication function with the communication apparatus.

40. The communication apparatus according to claim 36, wherein
the notification unit notifies the partner apparatus of the change or the inactivation of the at least part of the information by broadcasting a message using the second communication function.

41. The communication apparatus according to claim 36, wherein
the notification unit notifies the partner apparatus of the change or the inactivation of the at least part of the information by transmitting a unicast message using the second communication function.

42. The communication apparatus according to claim 41, wherein
the unicast message contains changed information of the at least part that has been changed out of the information.

43. The communication apparatus according to claim 36, wherein
the information includes parameters used in the communication based on the first communication function, and
the parameters include at least one of a network identifier, information indicating a used channel, an encryption type, an encryption key, an authentication type, an address of the communication apparatus, and an address of the partner apparatus.

44. The communication apparatus according to claim 36, wherein
the information includes information indicating a communication state of the communication based on the first communication function, and
the communication state includes information related to at least one of connection, a session, and a stream.

45. A control method for a communication apparatus with a first communication function, a second communication function that has lower power consumption than the first communication function, and a storage unit that stores information, the control method comprising:
keeping information for communication based on the first communication function stored in the storage unit, even after the communication based on the first communication function with a partner apparatus involved with communication is stopped, the information having been obtained from the partner apparatus;
determining whether the information stored in the storage unit is valid through communication based on the second communication function with the partner apparatus; and
resuming the communication based on the first communication function with the partner apparatus
upon re-obtaining the information for the communication based on the first communication function from the partner apparatus in a case where at least a part of the information stored in the storage unit is not valid, and
without re-obtaining the information for the communication based on the first communication function from the partner apparatus in a case where the information stored in the storage unit is valid.

46. A control method for a communication apparatus with a first communication function, a second communication function that has lower power consumption than the first communication function, and a storage unit that stores information, the control method comprising:
storing information for communication based on the first communication function in the storage unit, the information having been provided to a partner apparatus involved with communication; and
in a case where the information stored in the storage unit has been changed or inactivated, notifying the partner apparatus of a change or inactivation of at least a part of the information through communication based on the second communication function.

47. A non-transitory computer-readable storage medium storing a computer program for causing a computer provided in a communication apparatus to execute a control method, the communication apparatus having a first communication function, a second communication function that has lower power consumption than the first communication function, and a storage unit that stores information, the control method comprising:
keeping information for communication based on the first communication function stored in the storage unit, even after the communication based on the first communication function with a partner apparatus involved with communication is stopped, the information having been obtained from the partner apparatus;
determining whether the information stored in the storage unit is valid through communication based on the second communication function with the partner apparatus; and
resuming the communication based on the first communication function with the partner apparatus
upon re-obtaining the information for the communication based on the first communication function from the partner apparatus in a case where at least a part of the information stored in the storage unit is not valid, and
without re-obtaining the information for the communication based on the first communication function from the partner apparatus in a case where the information stored in the storage unit is valid.

48. A non-transitory computer-readable storage medium storing a computer program for causing a computer provided in a communication apparatus to execute a control method, the communication apparatus having a first communication function, a second communication function that has lower power consumption than the first communication function, and a storage unit that stores information, the control method comprising:
storing information for communication based on the first communication function in the storage unit, the information having been provided to a partner apparatus involved with communication; and
in a case where the information stored in the storage unit has been changed or inactivated, notifying the partner apparatus of a change or inactivation of at least a part of the information through communication based on the second communication function.
